(19) United States
(12) Patent Application Publication
(10) Pub. No.: US 2002/0019943 A1
(43) Pub. Date: Feb. 14, 2002

(54) Apparatus and method for preventing illegal reproduction/distribution of digital goods by use of physical goods

(76) Inventors: Soon-Young Cho, Sungnam-Shi (KR); Sang-Kyu Park, Seoul (KR)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/846,904

(22) Filed: May 1, 2001

(30) Foreign Application Priority Data
Jun. 16, 2000 (KR) 2000-33340

(51) Int. Cl. G06F 12/14; G06F 17/60

(52) U.S. Cl. 713/200; 705/51; 713/193

(57) ABSTRACT

Apparatus and method for preventing reproduction/distribution of digital goods by use of physical goods uses an inherent ID given to the physical goods. A first encrypted ID and an assignable identification name are also given to the goods. A second encrypted ID is generated when the assignable identification name registered upon the purchases of digital goods coincides with an inputted identification name. The present invention transfers, upon the purchase of the digital goods, the second encrypted ID and the purchased digital goods or the second encrypted ID and encrypted digital goods generated by encrypting the purchased digital goods according to the first encryption algorithm, and extracts the first encrypted ID from the second encrypted ID upon executing the digital goods. The extracted first encrypted ID is compared with the first encrypted ID given to the physical goods, and executes at least a part of the digital goods if the extracted first encrypted ID coincides with the first encrypted ID given to the physical goods.

### BACKGROUND OF THE INVENTION

1. Field of the Invention

The present invention relates to an apparatus for and a method of preventing illegal reproduction/distribution of digital goods transferred via online to a client by use of physical goods having an inherent ID and a first encrypted ID according to a first encryption algorithm from the inherent ID for executing at least a part of the transferred digital goods, and to a method of presenting digital goods to a third party by using the same.

2. Description of the Prior Art

Goods which are dealing objects in the Internet business are classified into physical goods and digital goods. The physical goods mean goods whose entity exists in the real world and which we can directly touch, such as music CDs which can be purchased in an Internet disc store, electronic products which can be purchased in an Internet shopping mall, and the like. However, in order for the dealings of physical goods to become successful in the Internet business, the goods dealings have to be smoothly associated with deliveries and logistics systems.

In the meantime, digital goods mean all goods which can be digitally produced, distributed, consumed, and stored, such as electronic books, games, MP3 music files, and the like, which can be downloaded through the Internet. However, the digital goods are essentially in a digital form, so easy to be transferred through the Internet, but not changed in quality even if copied or transferred. Therefore, illegal reproductions can be made as much as desired, so critical blows can be struck to a manufacturer of digital goods which require a high fixed production cost at the beginning. Accordingly, the reason digital goods manufacturers refrain from contents distributions in the Internet is based on the fear about illegal flows/distributions of digital goods through the Internet. Therefore, an explicit solution to the problem should be presented for balanced development of electronic commerce through the Internet.

In order to solve the problem of illegal flows/distributions of the digital contents, a method has been proposed in recent in which some digital goods are encrypted for transfer, a user is confirmed to be an authentic user based on security programs, keys, or the like downloaded into a user computer, and digital goods are reproduced only to an authorized user.

As an example of the method, a method has been proposed in which MP3 music files, a kind of digital goods, are encrypted for transfers according to a certain encryption algorithm to prevent the MP3 music files from illegal reproductions as well as to circulate the MP3 music files which can not be circulated on-line due to the copyright matters. For the above purpose, there are a “SecuMax” developed by Samsung Electronics Co. Ltd., and a “DigitapAudio” provided by the consortium of LG Electronics Co. Ltd., LG Internet Co. Ltd., and BR netcom Co. Ltd.

FIG. 1 is a block diagram for showing an embodiment of a SecuMax system of Samsung Electronics Co. Ltd. for protecting copyrights in the circulation of digital contents.

A reference numeral 10 indicates an authentication and contents management server, 20 a client personal computer, and 30 an MP3 player (The SecuMax system of Samsung Electronics Co. Ltd. is a player dedicated for SM3 files. For example, there are Yepp of Samsung Electronics, MPMan of MPMan.com, Inc., and the like, and there is also an MP3 player implemented by software itself.). In FIG. 1, if a user performs a membership registration in an authentication and contents management server 10 through a client personal computer 20 (Step 1), the authentication and contents management server 10 transfers a key to a client, that is, a client personal computer 20 (Step 2). If the key is transferred the client stores the key in the client personal computer 20 (Step 3), registers the key in the authentication and contents management server 10 (Step 4), requests the purchase of MP3 files to the authentication and contents management server 10 (Step 5). If the purchase request exists, the authentication and contents management server 10 transfers SM3 files generated by encrypting the MP3 files according to the client key to the client personal computer 20 (Step 6). Thereafter, the client personal computer 20 compares the key stored in itself and registered in the server 10 with the transferred client key, and transfers the SM3 files to an MP3 player 30 dedicated to SM3 files in case that the two keys are matched (Step 7). With the transfer of the SM3 files, the MP3 player 30 reproduces the SM3 files.

Accordingly, upon reproducing SM3 files, the reproduction is performed in case that a key stored in a client computer is exactly the same as a client key transferred together with the SM3 files. Accordingly, illegal reproductions are prevented since only an authenticated user can listen to encrypted MP3.

However, illegal reproduction of MP3 files can be made under the SecuMax system of Samsung Electronics Co. Ltd. in the case that a client A purchases and downloads the SM3 files, and transfers the downloaded SM3 files to a person B, the client A transfers a key of the client A to the person B or let the person B know his/her membership ID in order for the person B to receive the key of the client A, and the person B downloads the SM3 files transferred from the client A to an MP3 player. Accordingly, there exists a problem in that illegal distributions of digital contents can not be basically blocked up if the contents are transferred together with a key.

As stated above, a conventional method of encrypting digital goods basically has the limitation in maintaining a system for preventing the illegal distributions of contents by a digital contents manufacturer or a digital contents distributor who runs an electronic commerce site of dealing with digital goods since means themselves such as security programs, keys, or the like, which are downloaded to a user computer are digital signals movable in the Internet.

Further, what is taken into consideration in designing a system for preventing illegal distributions of digital goods is the flexibility of the system. In case of physical goods, everyone can purchase the goods, and mail or directly hand over the purchased goods to a third party as a gift, and the purchases for gifts actually takes considerable portion of sales.

Accordingly, if a method of preventing the illegal distributions basically blocks the digital goods transfer to a third party or the operations of digital goods transferred through a network, giving and taking digital goods as gifts become impossible, to thereby so much restrain free purchase forms of clients.

### SUMMARY OF THE INVENTION

In order to solve the above problems, an object of the present invention is to block the illegal distributions of digital goods by giving a certain role to physical goods such as a hardware or activating unit in which at least a part of the digital goods is executed.

Another object of the present invention is to enable the purchases of digital goods for gifts by giving a certain role to physical goods such as a hardware or activating unit in which at least a part of the digital goods is executed.

A further object of the present invention is to enable the blocking of illegal distributions of digital goods as well as the purchase of digital goods for gifts by giving a certain role to physical goods such as a hardware or activating unit in which at least a part of digital goods is executed.

A still further object of the present invention is to enable manufacturers of physical goods to participate in the distributions of digital contents and in profit sharing by giving a certain role to physical goods such as a hardware or activating unit.

A furthermore object of the present invention is to block the illegal distributions of digital goods by giving a certain role to physical goods such as a hardware or activating unit in which at least a part of digital goods is executed without encryption of the digital goods.

In order to achieve the above objects, the present invention for preventing reproduction/distribution of digital goods by use of physical goods uses an inherent ID which is given to the physical goods upon manufacturing of the physical goods in a manner that the inherent ID is exposed to a client upon purchase of the physical goods in order to be inputted from the client if requested, or stored in the physical goods without being exposed to the client, a first encrypted ID which is also given to the physical goods and encrypted according to a first encryption algorithm from the inherent ID, an assignable identification name for identifying the physical goods, and a second encrypted ID generated by encrypting the first encrypted ID according to a second encryption algorithm when the assignable identification name registered upon the purchases of digital goods including gift purchases coincides with an inputted identification name. The present invention transfers, upon the purchase of the digital goods, the second encrypted ID and the purchased digital goods or the second encrypted ID and encrypted digital goods generated by encrypting the purchased digital goods according to the second encryption algorithm, extracts the first encrypted ID by decrypting the second encrypted ID according to a decryption algorithm corresponding to the second encryption algorithm upon executing the digital goods, compares the extracted first encrypted ID with the first encrypted ID given to the physical goods, and executes at least a part of the digital goods, without decryption if the digital goods has not been encrypted or through decryption according to the decryption algorithm if the digital goods has been encrypted, in the physical goods only in case that the extracted first encrypted ID coincides with the first encrypted ID given to the physical goods, so that the illegal reproductions/distributions of the digital goods by use of the physical goods can be prevented.

Further, in accordance with the above constructions of the present invention, since the illegal reproductions/distributions of digital contents are basically prevented by use of physical goods, accurate settlements can be made with external digital contents providers, and even manufacturers of physical goods can participate in digital contents distributions and profit sharing, and since a certain role to physical goods in which at least a part of digital goods is executed is given, blocking of the illegal reproductions/distributions of the digital goods at the same time with enabling purchases of the digital goods as gifts can be achieved.

### BRIEF DESCRIPTION OF THE DRAWINGS

The above objects and other advantages of the present invention will become more apparent by describing in detail preferred embodiments thereof with reference to the attached drawings, in which:

FIG. 1 is a block diagram for showing an example of a SecuMax system of Samsung Electronics Co. Ltd. which is a conventional art for protecting copyrights in digital distributions of contents;

FIG. 2 is a view for explaining a basic structure and a control flow for preventing illegal reproductions/distributions of digital goods having a first execution portion and a second execution portion by use of physical goods according to a first embodiment of the present invention;

FIGS. 3a to 3d are views for explaining an example of a data structure suitable for physical goods such as a story-teller applied to the first embodiment, in which:

FIG. 3a is an exemplary view for showing the contents of a first execution portion of digital contents to be executed in a client interface 400 and the contents of a second execution portion of digital contents to be executed in an activating unit 500;

FIG. 3b is an exemplary view for showing a physical structure of a data structure of the digital contents shown in FIG. 3a;

FIG. 3c is an exemplary view for showing a logical structure of a data structure of the digital contents shown in FIG. 3b;

FIG. 3d is a view for schematically showing the separation of digital contents transferred to a client interface 400 into a first execution portion to be executed in the client interface 400 and a second execution portion to be executed in the activating unit 500, an output of the first execution portion from the client interface 400, and an output of the second execution from an activating unit 500;

FIG. 4 is a block diagram for showing an example of a structure of a central controller 200;

FIG. 5 is a block diagram for showing an example of a structure of a digital contents controller 300;

FIG. 6 is a block diagram for showing an example of a structure of a client interface 400;

FIG. 7 is a block diagram for showing an example of a structure of an activating unit 500;

FIG. 8 is a block diagram for showing an example of a structure of an electronic commerce controller 600; FIG. 9 is a flow chart for explaining a process for registering activating unit information in a central controller 200 after the purchase of an activating unit;

FIG. 10 is a flow chart for a case that a client is registered as a member who uses digital contents;

FIG. 11 is a flow chart for showing a transaction authentication according to a purchase of digital contents, that is, a generation of a second encrypted ID, and executions of downloading into a client interface 400;

FIGS. 12a to 12c are flow charts for showing a process for driving digital contents, respectively;

FIG. 13 is a flow chart for registering the number of times of downloading of digital contents in a database;

FIG. 14 is a flowchart for showing a process for providing digital contents as a gift;

FIG. 15 is a flow chart for showing a process for downloading digital contents to be provided as a gift;

FIG. 16 is a block diagram for showing a structure of an electronic commerce controller 600′ employed in a second aspect of the first embodiment of the present invention;

FIG. 17 is a flow chart for showing settlements by respective business proprietors of digital contents controller 300 according to the second aspect:

FIG. 18 is a block diagram for showing a structure of a central controller 200′ employed in a third aspect of the first embodiment of the present invention;

FIG. 19 is a flow chart for showing a transaction authentication according to a purchase of digital contents, that is, a production of a second encrypted ID and the execution of downloading into a client interface 400 according to the third aspect;

FIG. 20 is a flow chart for showing settlements by business proprietor who simultaneously runs a digital contents controller 300 and an electronic commerce controller 600′ according to the third aspect;

FIG. 21 is a view for explaining a basic structure and a control flow for preventing illegal reproductions/distributions of digital goods by use of physical goods according to a second embodiment of the present invention;

FIG. 22 is a block diagram for showing a central controller 200′ employed in a second embodiment of the present invention;

FIG. 23 is a block diagram for showing a digital contents controller 300′ employed in a second embodiment of the present invention;

FIG. 24 is a block diagram for showing a client interface 400′ employed in a second embodiment of the present invention;

FIG. 25 is a block diagram for showing an activating unit 500′ employed in a second embodiment of the present invention;

FIG. 26 is a block diagram for showing an electronic commerce controller 600″ employed in a second embodiment of the present invention;

FIG. 27a and FIG. 27b are flow charts for showing in detail a control flow for preventing reproductions/distributions of digital goods by use of physical goods according to a second embodiment of the present invention;

FIG. 28 is a flow chart for showing a different aspect for steps 1710 to 1740 with respect to operations of an activating unit of FIG. 27b;

FIG. 29 is a flow chart for showing a process for providing digital contents as a gift in a second embodiment of the present invention; and

FIG. 30 is a flow chart for showing a process for downloading digital contents provided as a gift in a second embodiment of the present invention.

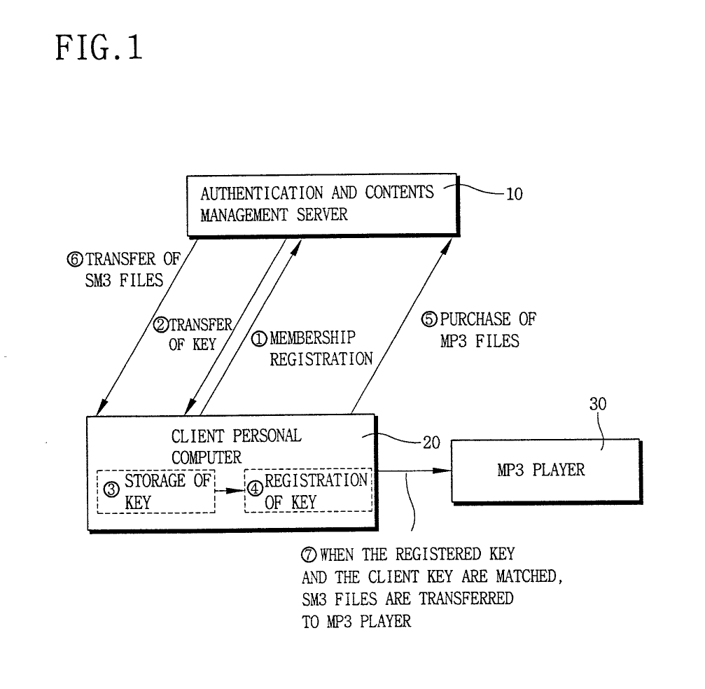

### DETAILED DESCRIPTION OF THE PREFERRED EMBODIMENTS

Hereinafter, the present invention will be described with reference to the accompanying drawings.

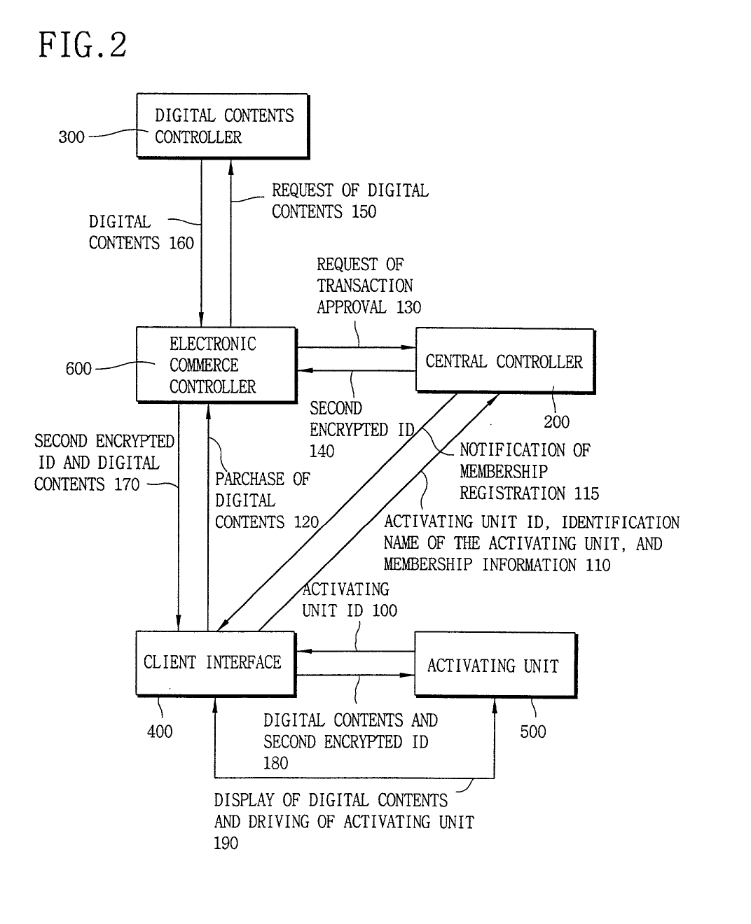

FIG. 2 is a view for explaining a basic structure and a control flow for preventing illegal reproductions/distributions of digital goods having a first execution portion and a second execution portion by use of physical goods according to a first embodiment of the present invention.

FIG. 2 shows a central controller 200, a digital contents controller 300, a client interface 400, an activating unit (an example of digital goods) 500, and an electronic commerce controller 600. If a client purchases the activating unit 500, connects the activating unit 500 to the client interface 400, and installs a installation program provided together with the activating unit or downloaded from a web site in the client interface 400, the installation program automatically takes in an activating unit ID 100 stored within the activating unit 500, or requests an input of the activating unit ID 100. The activating unit ID is an ID inherently given to the activating unit upon producing the activating unit 500, which can be stored in the activating unit or exposed to the client in a tag form on the outside of the activating unit. A business proprietor produces activating units in which the first encrypted ID generated by encrypting the activating unit ID according to a predetermined first encryption algorithm is stored.

The activating unit ID, an identification name of the activating unit assigned by the client, and membership information are transferred to the central controller 200 (Step 110). The central controller 200 examines whether the assigned-by-client identification name of the activating unit is already in use by another client, and, if the assigned-by-client identification name is not in use, produces data regarding the activating unit in an activating unit database by using the transferred information and notifies the fact of a new registration to the client of the client interface 400 (Step 115).

In the case that the client registers in advance the assigned-by-client identification name of the activating unit in the central controller 200 based on the activating unit ID, the assigned-by-client identification name of the activating unit, and membership information, the step for the new registration in the central controller 200 is not required.

In the case that the client requests contents, which are digital goods having a first execution portion and a second execution portion, for a purchase through the client interface 400 (Step 120), the assigned-by-client identification name of the activating unit which the client inputs and a goods code are transferred from the client interface 400 to the electronic commerce controller 600.

The electronic commerce controller 600 transfers the goods code of the selected-by-client digital goods and the assigned-by-client identification name of the activating unit to the central controller 200 and requests a transaction approval (Step 130). The central controller 200, when the transaction approval is requested (Step 130), searches the activating unit ID and its first encrypted ID in the activating unit database by using the assigned-by-client identification name of the activating unit transferred and transfers to the electronic commerce controller 600 a second encrypted ID generated by encrypting the first encrypted ID according to a predetermined second encryption algorithm (Step 140), and forms charges information on the corresponding client based on the goods code and the membership information corresponding to the assigned-by-client identification name.

The electronic commerce controller 600, if the transaction approval is done in the central controller 200, that is, if the second encrypted ID is transferred, requests the digital contents the client wishes to purchase to the digital contents controller 300 (Step 150). According to the digital contents request from the electronic commerce controller 600 (Step 150), the digital contents controller 300 transfers the corresponding digital contents to the electronic commerce controller 600 (Step 160). The electronic commerce controller 600 transfers the digital contents and its associated second encrypted ID to the client interface 400 (Step 170).

The client interface 400 stores the received second encrypted ID and digital contents in a goods database.

If the client executes the digital contents, the client interface 400 and the activating unit 500 can be operated in diverse manners.

Typical three manners are illustrated as blow.

The first illustrative case is that, if the client executes the digital contents, the client interface 400 separates the digital contents in the goods database into a first execution portion and a second execution portion at the same time separating the second encrypted ID from the digital contents, and transfers the separated second encrypted ID to the activating unit 500 in advance (Step 180).

In this case, the activating unit 500 receiving the second encrypted ID decrypts the second encrypted ID according to a second decryption algorithm corresponding to the second encryption algorithm, extracts the first encrypted ID, and compares the extracted first encrypted ID with the first encrypted ID stored in a memory thereof.

If the two are matched as a comparison result, it is judged that the activating unit is in an operation-available state, and the activating unit transfers to the client interface 400 a transfer request signal for the contents of the digital contents to be executed therein. If the two are not matched as the comparison result, the digital contents are considered to be duplicated, and the activating unit transfers an operation-rejecting signal to the client interface 400.

If there is a transfer request for the contents of the digital contents from the activating unit 500, the client interface 400 leaves in the client interface 400 the first execution portion (video signal and sound signal) to be executed in the client interface 400, and transfers to the activating unit 500 the second execution portion (operation signal and sound signal) to be executed in the activating unit 500. According to the transfer of the second execution portion of the digital contents to the activating unit 500, the activating unit executes the second execution portion in synchronization with the execution of the first execution portion of the client interface 400 (Step 190).

The second illustrative case is that, if the client executes the digital contents, the client interface 400 separates the digital contents in its goods database into a first execution portion and a second execution portion at the same time with separating the second encrypted ID from the digital contents, and transfers the separated second execution portion and the separated second encrypted ID to the activating unit 500 (Step 180).

In this case, the activating unit 500 receiving the second encrypted ID decrypts the second encrypted ID according to the second decryption algorithm corresponding to the second encryption algorithm, extracts the first encrypted ID, and compares the extracted encrypted ID with the first encrypted ID stored in a memory therein. If the two are matched as a comparison result, the activating unit 500 transfers a signal indicating an operation-available signal to the client interface 400, and, if not matched, takes into account that the digital contents are duplicated, and transfers an operation-rejecting signal to the client interface 400.

Based on the signal indicating the operation-available state from the activating unit 500, the client interface 400 executes the first execution portion (video signal and sound signal) of the digital contents, and the activating unit 500 executes the second execution portion (operation signal and sound signal) in synchronization with the execution of the first execution portion (Step 190).

The third case is that, if the client executes digital contents, the client interface 400 separates the second encrypted ID from the digital contents and transfers the separated second encrypted ID in advance to the activating unit 500 (Step 180).

In this case, the activating unit 500 receiving the second encrypted ID decrypts the second encrypted ID according to the second decryption algorithm corresponding to the second algorithm, extracts the first encrypted ID, and compares the extracted first encrypted ID with the first encrypted ID stored in a memory thereof.

If matched as a comparison result, it is judged that the activating unit 500 is in the operation-available state, and the activating unit 500 transfers to the client interface 400 a transfer request signal with respect to the contents of the digital contents to be executed therein, and, if not matched as the comparison result, the activating unit 500 takes into account that the digital contents are duplicated and transfers the operation-rejecting signal to the client interface 400.

If there is a transfer request for the contents of the digital contents from the activating unit 500, the client interface 400 separates the digital contents into a first execution portion (video signal and sound signal) to be executed in the client interface 400 and a second execution portion (operation signal and sound signal) to be executed in the activating unit 500, and transfers to the activating unit 500 the second execution portion to be executed in the activating unit 500. According to the transfer of the second execution portion of the digital contents to the activating unit 500, the activating unit executes the second execution portion to be executed therein in synchronization with the execution of the first execution portion of the client interface 400 (190).

As stated above, it is described that the identification name of the activating unit is assigned by a client, but the name can be assigned to the client by a business proprietor who manages the central controller. The identification name establishes a relationship between an activating unit ID not exposed to the client and an authentic owner of the activating unit ID in case that the present invention is embodied in a manner that the activating ID is not exposed to the client, to thereby enable digital goods to be presented as a gift to a third party by using constructions of the present invention to be described later. In case that the activating unit ID is provided to an activating unit purchaser in a tag form and easy to be memorized, the giving of the identification name may not be separately required in the embodiment of the present invention.

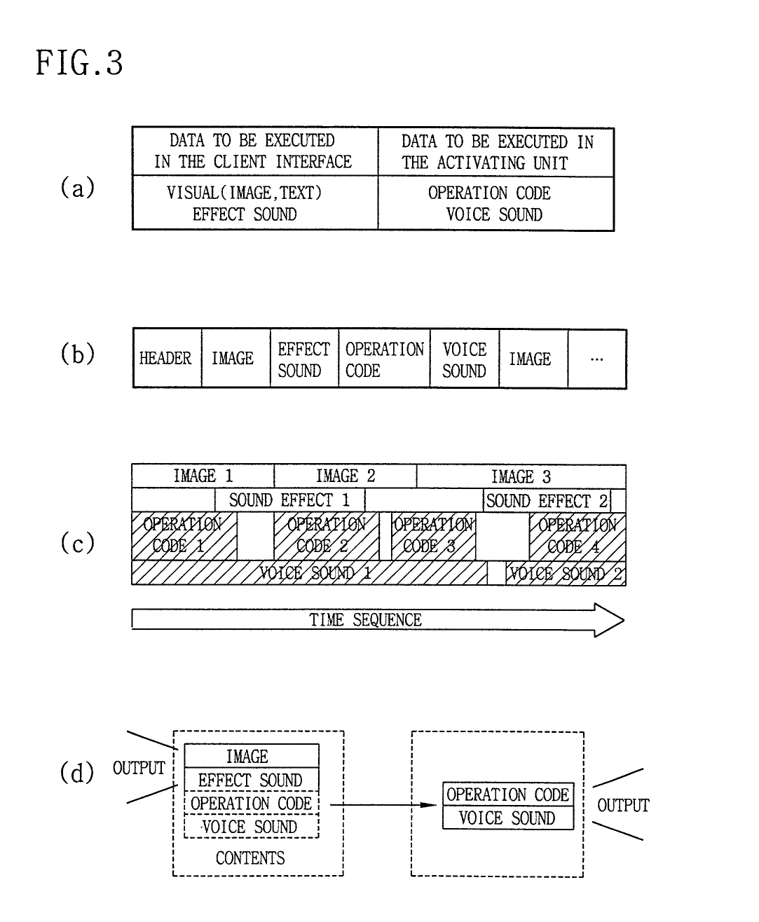

Next, in case that the physical goods applied to the first embodiment in the construction described above is a story-teller, an example of a data structure suitable for this is described with reference to FIGS. 3a to 3d.

FIG. 3a shows the contents of a first execution portion of digital goods to be executed in the client interface 400 and the contents of a second execution portion to be executed in the activating unit 500, the contents of the first execution portion include visual (image, text) data and effect sound data, and the contents of the second execution portion include operation code data and voice sounds. The story-teller (activating unit 500) tells children the contents of a nursery tale in a narrator voice together with movements of the story-teller.

The processing of background displays of the nursery tale contents and characters can be performed in the client interface 400 together with background sound processing. Described in more detail, the narrator voice may be outputted through speakers built in the story-teller, the story-teller itself may be operated according to operation codes, the background of the nursery tale contents may be outputted on a monitor of the client interface 400, and the background sound of the nursery tale may be outputted through the speakers of the client interface 400.

FIG. 3b is a view for showing a physical structure of a data structure of the digital contents shown in FIG. 3a, in which a header is positioned on the front portion of one file and such data types as image, effect sound, operation code, and voice sound are consecutively repeated in the remaining portion of one file.

FIG. 3c is a view for showing a logical structure of a data structure of the digital contents shown in FIG. 3b, in which the logical structure of the digital contents indicates a form in which various data types are arranged by time according to a time sequence. As shown in FIG. 3c, while image 1, image 2, and image 3 on the monitor of the client interface 400 are executed, sound effect 1 and sound effect 2 are respectively executed through the speakers of the client interface 400 in a predetermined time sequence. In synchronization with the execution of the first execution portion of the digital contents in the client interface 400, the activating unit 500 executes operation code 1, operation code 2, operation code 3, and operation code 4 in the predetermined time sequence through an operation mechanism of its own, and executes voice sound 1 and voice sound 2 of the contents of an oral nursery tale of a narrator through the speakers built in the activating unit in a predetermined time sequence. A signal separation processor, which will be described later, in the client interface 400 reads such digital contents, separates the digital contents into a first execution portion to be executed in the client interface 400 and a second execution portion to be executed in the activating unit 500, and separates the first execution portion into data to be executed on the monitor and data to be executed in the speakers.

FIG. 3d is a view for schematically showing that digital contents transferred to the client interface 400 are separated into a first execution portion to be executed in the client interface 400 and a second execution portion to be executed in the activating unit 500 by means of the signal separation processor, the first execution portion is outputted from the client interface 400, and the second execution portion is outputted from the activating unit 500.

The digital contents as described in detail are constructed through a process as below.

The digital contents according to a first embodiment, as stated above, are mainly constructed with sound and graphic data. The production process of the data is basically constituted with a first step for defining, producing, and storing various forms of data, and a second step for arranging the stored data and making new contents, even though the production process of the data can be changed according to what data the client interface 400 and the activating unit 500 respectively output.

In the first step, data (visual, effect sound) to be executed in the client interface 400 and voice sound data to be executed in the activating unit 500 are built in a database form by being directly manufactured by a contents provider or by using the existing data in a format to be respectively executed through the monitor and speakers of the client interface 400 and the speakers of the activating unit 500. The operation code data of the data to be executed in the activating unit 500 is produced in the second step to be described later.

In the second step, the contents provider uses a contents manufacturing program such as Macromedia Director provided by the main office or a third party to arrange data, which is built in the database in the first step, to be executed in the monitor and speakers of the client interface 400 and the speakers of the activating unit 500 in a manner fit to the time sequence.

At this time, by using an editor program such as Xtras supporting the above contents manufacturing program provided by the main office, the operation code data to be process in the activating unit together with data built in the database in the first step to be executed in the speakers of the activating unit is produced and arranged in a manner fit to the time sequence. An example of the digital contents formed through the above first step and second step is shown in FIG. 3c.

Next, constituents necessary for the encryption and decryption according to the first embodiment of the present invention will be described.

First, the necessary constituents are schematically shown in Table 1.

TABLE 1

| Activating | Encrypted | Public | Private | Assigned-by-user |
|---|---|---|---|---|
| unit ID | ID | key | key | identification name |
| AA | Aa | A_{dk} | Aₑₖ | Aaaaa |
| BB | Bb | B_{dk} | Bₑₖ | Bbbbb |
| CC | Cc | C_{dk} | Cₑₖ | ccccc |

Respective item values in Table 1 are arbitrary values for an example.

(1) Activating Unit ID

The activating unit ID is an inherent ID of an activating unit 500, which is stored in the activating unit 500 upon the outgoing from a factory or attached in a tag form to the activating unit 500 to be known to a client.

The activating unit ID is required for the central controller 200 to recognize the activating unit 500 and give a use authority, and should be registered in the central controller 200 for the operations of the activating unit after its purchase. During the registration step, the activating unit ID is read by an installation program when executing the installation program with the connection of the client interface 400 and the activating unit 500 and transferred to the central controller 200, or the activating unit ID is transferred to the central controller 200 with a client's input in response to an input request of the installation program during the execution of the installation program.

The activating unit ID can be, for example, constituted with English letters and numbers and include a check bit in the middle for preventing error.

(2) Encrypted ID

The encrypted ID can be produced by encrypting the activating unit ID by the known multiletter-replacing encryption method. A table for keys/columns/rows necessary for the multiletter-replacing encryption method are shown as below and English letters and numbers can be arranged.

TABLE 2

| | | | | | | |
|---|---|---|---|---|---|---|
| A | B | C | D | E | 0 | 5 |
| F | G | H | I | J | 1 | 6 |
| K | L | M | N | O | 2 | 7 |
| P | Q | R | S | T | 3 | 8 |
| U | V | W | X | Y | 4 | 9 |

The encryption principle will be described based on Table 2.

First, a plain text is divided by two letters. Let the first letter be @ and the second letter

[Principle 1] if @ and # appear on the same row, take letters just on the right of the @ and #, respectively.

[Principle 2] if @ and # appear on the same column, take letters just below the @ and #, respectively.

[Principle 3] if @ and # appear on different row and column, take letters on the row and column enabling a rectangular shape to be drawn.

[Principle 4] if @ and # are the same letters, insert an arbitrary letter “Z”.

Let an activating unit ID “AA” shown in Table 1 be “HO-AT5ANXXE”. In order to encrypt the activating unit ID, the activating unit ID is grouped by two letters as blow. That is,

[HO] [AT] [5A] [NX] [XE]

Therefore, the activating unit ID will appear as below by using the row/column table of Table 2 and the multiletter-replacing encryption method. That is,

[JM] [EP] [AB] [SD] [YD]

Accordingly, the encrypted ID of the activating unit ID of “HO-AT5ANXXE” becomes “JM-EPABSDYD”.

The encrypted ID is stored in a component of the activating unit 500 such as ROM only once. The contents can not be altered, but recognized by a particular algorithm and a public key.

The encrypted ID plays a role of an electronic signature in a public key algorithm, and the encrypted ID is re-encrypted and included in digital contents. Therefore, a received encrypted ID becomes an important factor in grasping whether digital contents are illegally reproduced/distributed or not. Different private keys and algorithms for the second encryption produce different second encrypted ID values with respect to the same encrypted ID. Therefore, a different encrypted ID is extracted if a second encrypted ID altered by a public key and a decryption algorithm in the activating unit 500 is decrypted.

(3) Public Key and Private Key

The central controller 200 produces a public key and a private key by using an encrypted ID produced with respect to respective activating units by a public key-producing algorithm. The public key and private key are different values to each other. A produced private key is hidden and associated with the activating unit ID and encrypted ID in a database of the central controller 200. The central controller 200 produces a second encrypted ID by performing the second encryption, together with the private key, with respect to an encrypted ID based on the second encryption algorithm in the central controller 200. The second encrypted ID included in the contents is transferred to the activating unit 500 through the client interface 400. The produced public key is safely stored in the activating unit together with at least the encrypted ID and the decryption algorithm by an ROM writing software upon taking the activating unit out of a factory, and the public key is employed for interpreting the second encrypted ID transferred with the digital contents in the activating unit 500 together with a decryption algorithm.

The activating unit 500 decrypts the second encrypted ID by means of the public key and the decryption algorithm, and check whether the encrypted ID generated by the decryption of the second encrypted ID is the same as the encrypted ID given to the activating unit. If the two are not the same, the activating unit rejects the execution of the digital contents (digital goods) as stated above.

(4) Identification Name

An identification name is a unique name with which an activating ID is matched, given by a user to be easily memorized compared to the activating unit ID given by a business proprietor and difficult to be memorized, and employed when making an electronic commerce.

In the detailed description, even though the identification name of the activating unit is described to be assigned by a client, the identification name can be assigned by a business proprietor who manages the central controller. The identification name establishes a relation between an activating unit ID not exposed to the client and an authentic owner of the activating unit in case that the present invention is embodied in a manner that the activating unit ID is not exposed to the client, and enables to present digital goods to a third party by using a construction to be described later according to the present invention. However, the giving of the identification name may not be separately required in the embodiment of the present invention in case that the activating unit ID is provided to a purchaser of the activating unit in a tag form and easy to be memorized.

Next, an example of performing the second encryption and the decryption of an encrypted ID are described with [Step 1] to [Step 7] which are already known.

[Step 1] take two large prime numbers p and q, and define n as p*q.

Example) take p as 47, and q as 59. Therefore n becomes p*q=47*59=2773.

[Step 2] take a large random number d in a prime number relation with a number (p−1)*(q−1)

Example) (p−1)*(q−1)=2668 and arbitrarily take d as 157.

[Step 3] obtain e being an integer between 1 and (p−1)*(q−1), and being 1 when multiplying d which satisfies e*d=1 (MOD (p−1)*(q−1)), that is, obtained in the above and taking a remainder with (p−1)*(q−1).

Example) e satisfying 157*e=1 (mod2668) becomes 17.

[Step 4] store a pair of e and n, that is, (e, n) referred to as a public key in an activating unit.

Example) make (17, 2773) a public key and secretly store the public key in the activating unit.

[Step 5] divide an encrypted ID to be transferred into proper blocks, and express the encrypted ID as numbers from 1 to n.

Example) let an encrypted ID be “JMEPABSDYD”.

A method for expressing the encrypted ID as numbers from 1 to 2773 is to define numbers corresponding to alphabet as below.

SPACE=00, A=01, B=02, C=03, . . . , Z=26

Accordingly, the encrypted ID becomes 10 13 05 16 01 02 19 04 25 04.

Becoming up to 2773, if gathered by two, the above numbers will be (1013) (0516) (0102) (1904) (2504) all of which are smaller than 2773.

[Step 6] a remainder C obtained when divided by n after respective encrypted ID are raised to dth power is transferred as a second encrypted ID ( (d, n) becomes a private key).

Example) respective numbers are raised to dth (=157th) power and then divided by 2773, to obtain a remainder.

For example, (1013) is raised to 157^{th} power and then divided by 2773, bringing a remainder of 1335. Applications of the same calculations to the remaining numbers result in (1335) (0563) (0309) (1741) (1520) (0116).

[Step 7] an encrypted ID is obtained by calculating a remainder occurring when C, a transferred second encrypted ID, is raised to eth power and then divided by n.

Example) an original text is obtained when respective numbers of the second encrypted ID is raised to dth (=17^{th}) power and then divided by 2773. For example, a remainder 1013 is obtained when an encryption number 1335 is raised to 17^{th} power and then divided by 2773. Accordingly, the encrypted ID is decrypted into “JMEPABSDYD”.

Hereinafter, based on the above descriptions, the first embodiment of the present invention is mainly classified into 3 aspects which are:

Firstly, an aspect that one business proprietor directly runs and manages the central controller 200, the electronic commerce controller 600, and the digital contents controller 300;

Secondly, an aspect that a main business proprietor runs the central controller 200 and the electronic commerce controller 600 and another business proprietor directly manufactures digital contents and runs the digital contents controller 300; and

Thirdly, an aspect that a main business proprietor runs the central controller 200, and another business proprietor runs the electronic commerce controller 600 and the digital contents controller 300 with direct manufacturing of the digital contents.

Hereinafter, the respective aspects are described in more detail.

[First Aspect of the First Embodiment]

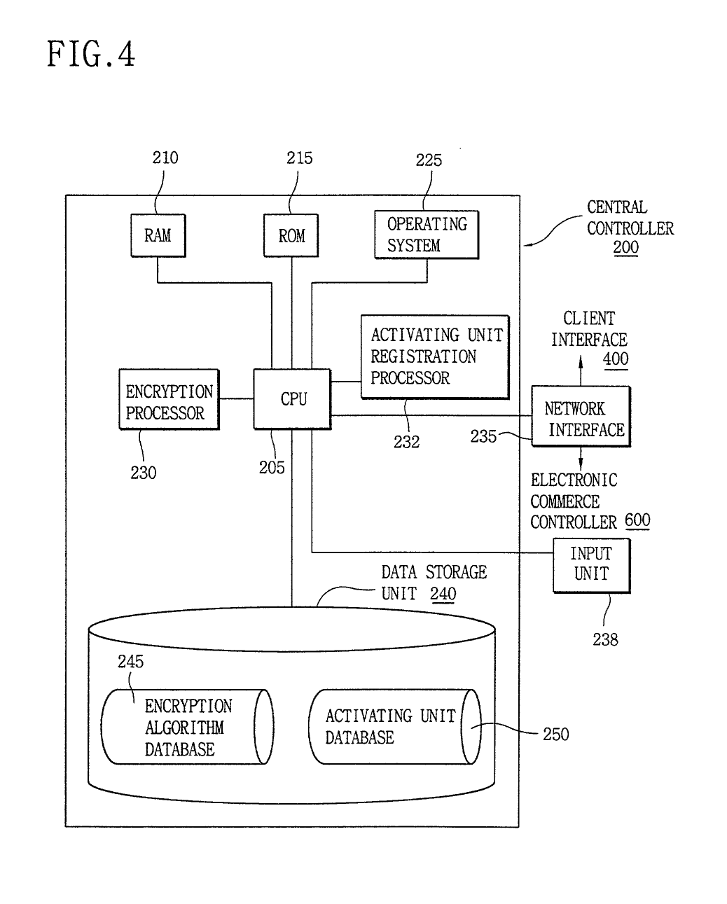

The operations of the first aspect that one business proprietor directly runs and manages the central controller 200, the digital contents controller 300, and the electronic commerce controller 600 by using the basic structure according to the first embodiment of the present invention, as shown in FIG. 2, will be described in more detail with reference to FIG. 4 to FIG. 15.

FIG. 4 is a block diagram for showing a structure of a central controller 200.

In the structure of FIG. 4, the central controller 200 has a CPU (205), a RAM (210), a ROM (215), an operating system (O/S) 225, an encryption processor 230, an activating unit registration processor 232, a network interface 235, an input unit 238, and a data storage unit 240.

The hardware of the central controller 200 may be a general personal computer, workstation, or enterprise class server, which has an enough memory and a processing capacity to process mass transactions, mathematical calculations, database searches and updates.

The CPU 205 controls the overall operations of the central controller 200, the RAM 210 is for temporarily storing data occurring during the process, the ROM 215 is for storing programs for booting the central controller 200 and the like, and the operating system (O/S) 255 is software stored in a hard disc in general and for efficiently operating the CPU 205 and other constituents.

The encryption processor 230, based on an activating ID searched by using a goods code and an identification name assigned to an activating unit which are transferred from the electronic commerce controller 600, extracts an encrypted ID corresponding to the searched activating unit ID from the activating unit database 250 to be described later, generates a second encrypted ID by using an algorithm selected from an encryption algorithm database 245 to be described later, and transfers the second encrypted ID to the electronic commerce controller 600.

The activating unit registration processor 232 stores in the database 250 and manages the activating unit ID received from the client interface 400, the identification name assigned to the activating unit, an activating unit registration date, and the like.

The network interface 235 is a connection part for connection with CPU 205 to the electronic commerce controller 600 and the client interface 400, and the connections to which can be made with LAN, dedicated lines, public networks, personal communication system (PCS), cellular, microwave, satellite networks, or other wire/wireless data communication networks. The input unit 238 may be a keyboard, a mouse, a voice recognizer, an operation button, or the like, and data and so on are inputted to control the central controller 200 through the input unit 238.

For the data storage unit 240, a hard disc (Magnetic or Optical storage units), CD-ROM drive, flash memory, or the like may be employed, and the encryption algorithm database 245 and the activating unit database 250 are included.

The encryption algorithm database 245 manages encryption algorithm classification codes and encryption algorithms and makes frequently changeable use of the encryption algorithm be possible.

The activating unit database 250 manages identification names assigned to activating units, activating unit registration dates, passwords, encrypted IDs, and the like.

Database software such as ORACLE 8i may be employed for producing and managing such database.

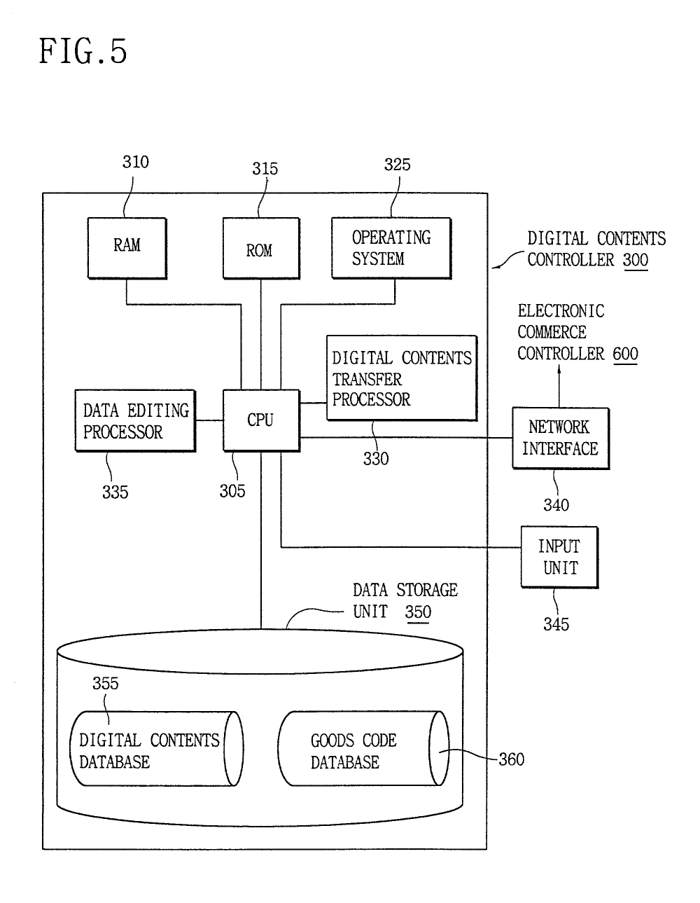

FIG. 5 is a block diagram for showing a structure of a digital contents controller 300.

In the structure of FIG. 5, the digital contents controller 300 comprises a CPU 305, a RAM 310, a ROM 315, an operating system (O/S) 325, a digital contents transfer processor 330, a data editing processor 335, a network interface 340, an input unit 345, and a data storage unit 350. The hardware of the digital contents controller 300 may be a general personal computer, workstation, or enterprise class server which has enough memory and processing capability to process mass transactions and database searches and updates.

The CPU 305 controls the overall operations of the digital contents controller 300, the RAM 310 is for temporarily storing data occurring during the process, the ROM 315 is for storing programs for booting the digital contents controller 300 and the like, and the operating system (O/S) 325 is software for efficiently operating the CPU 305 and the other constituents, which is generally stored in a hard disc.

The digital contents transfer processor 330 searches digital contents requested from the electronic commerce controller 600 in the digital contents database 355 and transfers the searched digital contents to the electronic commerce controller 600.

The data editing processor 335, when preparing digital contents, forms a signal (a first execution portion) to be executed in the client interface 400 and a signal (a second execution portion) to be executed in the activating unit 500.

The network interface 340 is a connection part for the connection with the electronic commerce controller 600, which can be connected via LAN, dedicated lines, public networks, personal communication systems (PCS), cellular, microwave, satellite network, or other wire/wireless data communication networks.

For the input unit 345, a keyboard, a mouse, a voice recognizer, an operation button, or the like may be employed, through which data and the like for controlling the digital contents controller 300 are inputted.

The data storage unit 350 may be a hard disc (Magnetic or Optical storage units), a CD-ROM drive, a flash memory or the like, in which a digital contents database 355 and a goods code database 360 are included.

The digital contents database 355 is a database for managing digital contents by goods codes

The goods code database 360 is a database for managing goods codes.

Database software such as ORACLE 8i may be used for producing and managing the database.

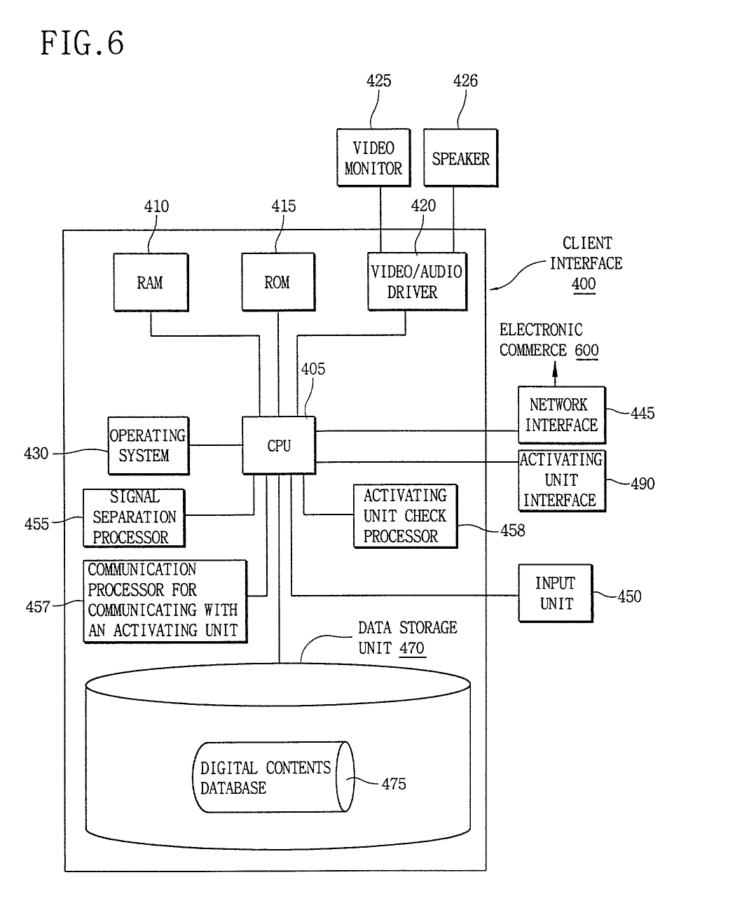

FIG. 6 is a block diagram for showing a structure of the client interface 400.

In the structure of FIG. 6, the client interface 400 includes a CPU 405, a RAM 410, a ROM 415, a video/audio driver 420, a video monitor 425, a speaker 426, an operating system (O/S) 430, a network interface 445, an input unit 450, a signal separation processor 455, a communication processor 457 for communicating with an activating unit, an activating unit check processor 458, a data storage unit 470, and an activating unit interface 490.

The hardware of the client interface 400 may be a general personal computer, a workstation, or an Internet TV, which has an input unit such as a keyboard, a mouse, a voice recognizer, a remote controller, or the like, a display unit such as a video monitor, an arithmetic unit such as a CPU, a network interface unit such as a modem, and perform a transaction process, arithmetical calculations, and database searches and updates.

The CPU 405 controls the overall operations of the client interface 400, the RAM 410 is for temporarily storing data occurring during the process, the ROM 415 is for storing programs and the like for booting the client interface 400, and the operating system (O/S) 430 is software stored in a hard disc in general and for efficiently operating the CPU 405 and other constituents.

The video/audio driver 420 interprets a signal received from the signal separation processor 455 and executes the signal through the video monitor 425 and the speaker 426.

For the video monitor 425, a general computer monitor, a TV monitor, or the like may be employed.

The network interface 445 is a connection part for connection with the electronic commerce controller 600, which can be connected via LAN, dedicated lines, public networks, personal communication systems (PCS), cellular, microwave, satellite networks, or other wire/wireless data communication networks.

For the input unit 450, a keyboard, a mouse, a voice recognizer, a remote controller, or the like may be employed.

When executing the digital contents, the signal separation processor 455 interprets digital contents separates the digital contents into the signal (the first execution portion) to be executed in the client interface 400 and the signal (the second execution portion) to be executed in the activating unit 500, and transfers the first execution portion to be executed in the client interface 400 to the video/audio driver 420 and the second execution portion to be executed in the activating unit 500 to the communication processor for communicating with the activating unit 500.

The communication unit 457 for communicating with the activating unit transfers the signal received from the signal separation processor 455 to the activating unit 500.

The activating unit check processor 458 connects the activating unit 500 to the client interface 400, checks whether the activating unit is in a malfunction, and reads an activating unit ID in the activating unit.

The data storage unit 470 may be a hard disc (Magnetic or Optical storage units), a CD-ROM drive, a flash memory, or the like, which includes the digital contents database 475.

The digital contents database 475 manages digital contents client purchased.

The activating unit interface 490 is a connection part for connection with the activating unit 500, for which the RS-232, USB, or Bluetooth may be used.

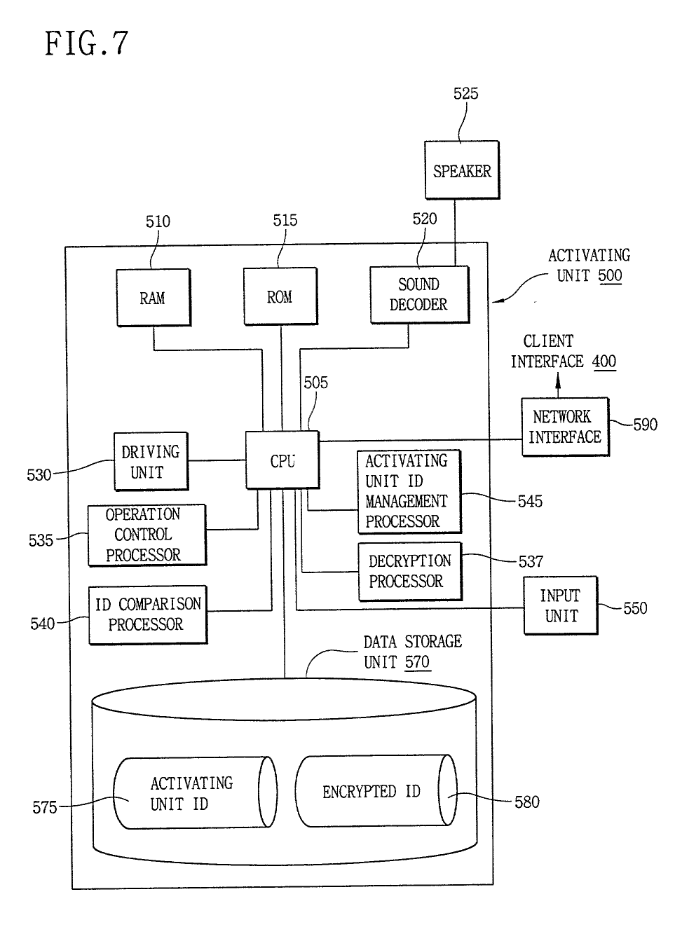

FIG. 7 is a block diagram for showing a structure of an activating unit 500. In the structure of FIG. 7, the activating unit 500 includes a CPU 505, a RAM 510, a ROM 515, a sound decoder 520, a speaker 525, a driving unit 530, an operation control processor 535, decryption processor 537, an ID comparison processor 540, an activating unit ID management processor 545, an input unit 550, a data storage unit 570, and a network interface 590.

The CPU 505 controls the overall operations of the activating unit 500, the RAM 510 is for temporarily storing data occurring during the process, and the ROM 515 is for storing programs and the like for booting the activating unit 500.

The sound decoder 520 interprets a signal regarding sound separated and transferred by the operation control processor 535, and the interpreted signal is executed through the speaker 525.

The driving unit 530 drives the activating unit according to an operation control signal received at the operation control processor 535, which includes a motor, magnets, gears, belts, and the like.

The operation control processor 535 interprets the operation control signal transferred from the client interface 400, transfers a signal regarding operations to the driving unit 530, and transfers the signal regarding sound to the sound decoder 520.

The decryption processor 537 reads a second encrypted ID transferred from the client interface 400, extracts a first encrypted ID by using a decryption algorithm, and transfers the extracted first-encrypted ID to the ID comparison processor 540.

The ID comparison processor 540 compares the first encrypted ID extracted by the decryption processor 537 with a first encrypted ID 580 given to the activating unit, and transfers to the client interface 400 a contents-executable state if matched or a contents-non-executable state if not matched.

The activating unit ID management processor 545 reads the activating unit ID stored in the activating unit.

For the input unit 550, a keyboard, a mouse, a voice recognizer, an operation button, or the like may be employed.

The data storage unit 570 may be a hard disc (Magnetic or Optical storage units), a CD-ROM drive, a flash memory, or the like, which includes an activating unit ID database 575 and an encrypted ID database 580.

The activating unit ID database 575 manages activating unit IDs, activating unit manufacturer IDs, activating unit manufacture dates, and the like.

The encrypted ID database 580 manages encrypted IDs, encrypted ID generation dates, and the like.

The network interface 590 uses the RS-232, USB, Bluetooth, or the like for the connections with the client interface 400.

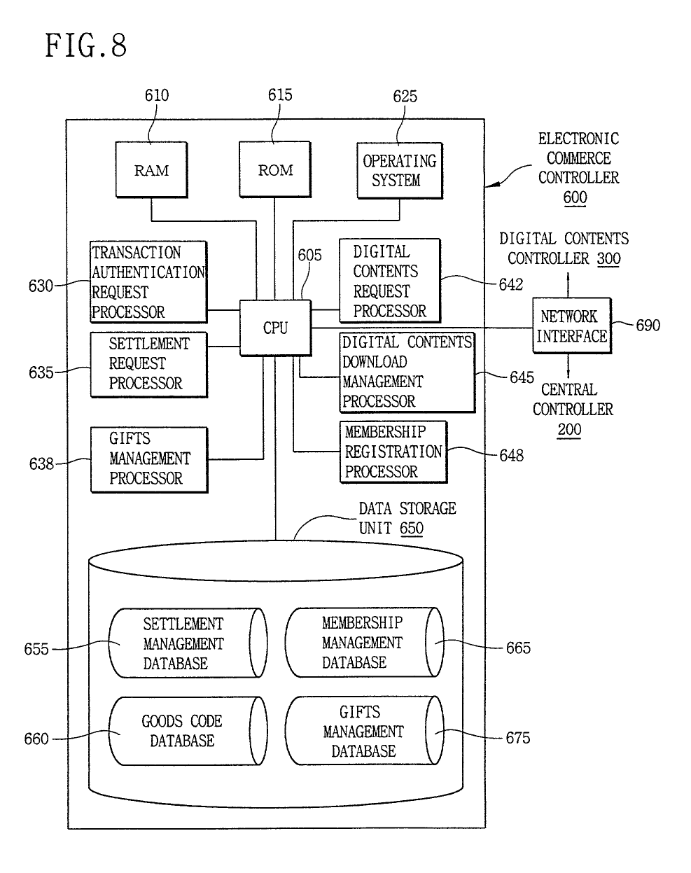

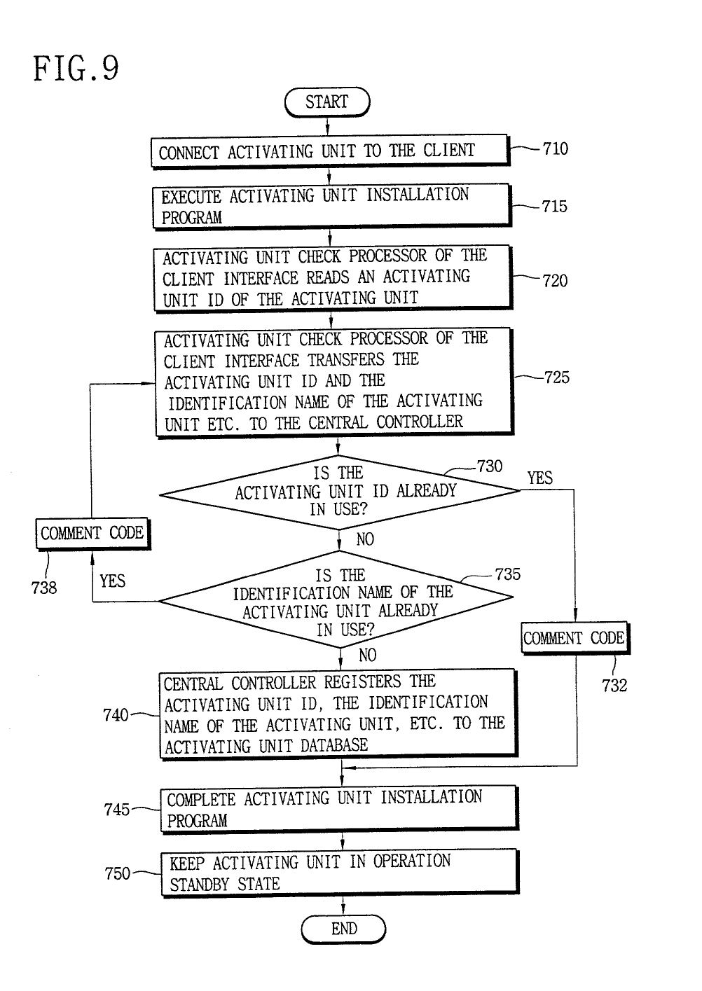

FIG. 8 is a block diagram for showing a structure of an electronic commerce controller 600.

In the structure of FIG. 8, the electronic commerce controller 600 includes a CPU 605, a RAM 620, a ROM 615, an operating system (O/S) 625, a transaction authentication request processor 630, a settlement request processor 635, a gifts management processor 638, a digital contents request processor 642, a digital contents download management processor 645, a membership registration processor 648, a data storage unit 650, and a network interface 690.

The hardware of the electronic commerce controller 600 may be a general personal computer, a workstation, or an enterprise class server, which has enough memory and processing capacity to perform mass transaction processes, and database searches and updates.

The CPU 605 controls the overall operations of the electronic commerce controller 600, the RAM 610 is for temporarily storing data occurring during the process, the ROM 615 is for storing programs and the like for booting the electronic commerce controller 600, and the operating system (O/S) 625 is software for efficiently operating the CPU 605 and other constituents, which is generally stored in a hard disc.

The electronic commerce controller 600 is operated as a web server for providing information to client by using a web browser such as the Netscape Navigator developed by Netscape or the Explorer developed by Microsoft.

The transaction authentication request processor 630 transfers a goods code and an identification name assigned to the activating unit, both of which are received from the client interface 400, to the central controller 200, requests a transaction authentication, that is, a second encrypted ID, and transfers the received second encrypted ID to the digital contents transfer management processor 645.

The settlement request processor 635 is a processor for connection with an external settlement institutions.

The gifts management processor 638, in case that a client presents digital contents to another member as a gift, transfers to an e-mail system of the member who is to receive the gift an email address and an URL of the digital contents controller in which the goods code to be presented exists.

The digital contents request processor 642 requests the transfer of the digital contents for a client to be purchased by a client to the digital contents controller 300.

The digital contents transfer management processor 645 transfers to the client interface 400 the second encrypted ID received from the central controller 200 and the digital contents received from the digital contents controller 300, and manages whether the transfer is normally completed.

The membership registration processor 648, when a client registers membership, stores in the membership management database 665 and manages membership ID, name, password, address, nationality, e-mail address, birth date, and the like, regarding the client.

The data storage unit 650 may be a hard disc (Magnetic or Optical storage units), a CD-ROM drive, a flash memory, which includes the settlement management database 655, the goods code database 660, the membership management database 665, and the gifts management database 675.

The settlement management database 655 is a database of managing the settlement contents with external settlement institutions, which manages membership IDs, settlement institutions IDs, settlement card kinds, settlement dates, settlement amounts, and the like.

The goods code database 660 manages goods codes, manufacture dates, manufacture languages, original composer, goods prices, settlement ratios, the number of times of transfers, and the like.

The membership management database 665 manages membership IDs, names, passwords, addresses, residing countries, nationalities, e-mail addresses, birth dates, purchased goods code list, registration dates, and the like, regarding members.

The gifts management database 675 is a database for managing goods codes and mails prepared when a member presents digital contents as a gift to another member, which manages gift-sending members' membership IDs and names, identification names of activating units of gift-receiving members (gift recipients), gift-receiving members' names, and goods codes and emails transferred by gift-sending members, and the like.

Database software such as ORACLE 8i is used for producing and managing the database.

The network interface 690 shown in FIG. 8 is a connection part for connection with the central controller 200 and the digital contents controller 300, which may be connected via LAN, dedicated lines, public networks, personal communication systems (PCS), cellular, microwave, satellite networks, or other wire/wireless data communication networks. The present invention will be described based on the detailed structures with respect to the respective constituents.

FIG. 9 is a flow chart for explaining a process for registering activating unit information in a central controller 200 after the purchase of an activating unit.

In case that an activating unit 500 is connected to the client interface 400 after the purchase of the activating unit 500, in order to register activating unit information to the activating unit database 250 of the central controller 200, if a client connects the activating unit 500 to the client interface 400 (Step 710) and executes an activating unit installation program in the client interface 400 (Step 715), the activating unit check processor 458 of the client interface 400 reads an activating unit ID of the activating unit 500 (Step 720).

If the activating unit check processor 458 of the client interface 400 transfers the activating unit ID and information inputted by the client such as the identification name assigned to the activating unit, and the like to the central controller 200 (Step 725), the central controller 200 searches the activating unit database 250 and examines whether the activating unit ID is already in use (Step 730). The existence of the activating unit ID means a duplicated activating unit, so the activating unit check processor 458 displays a comment code of such meaning on the monitor of the client interface 400 (Step 732), and completes the activating unit installation program (Step 745). If the same activating unit ID does not exist, the central controller 200 examines whether the identification name assigned to the activating unit is already in use (Step 735). The existence of the identification name of the activating unit means that another member is already using the activating unit, so the activating unit processor 458 displays a comment code of such meaning on the monitor 425 of the client interface 400 (Step 738), re-displays a screen for inputting an identification name of an activating unit, and transfers a new identification name of an activating unit and the like to the central controller 200 (Step 725).

If the same activating unit ID does not exist, the central controller 200 registers the activating ID, the identification name assigned to the activating unit, and the like, to the activating unit database 250 (Step 740) and then completes the activating unit installation program (Step 745), so the activating unit 500 stays in an operation standby state (Step 750).

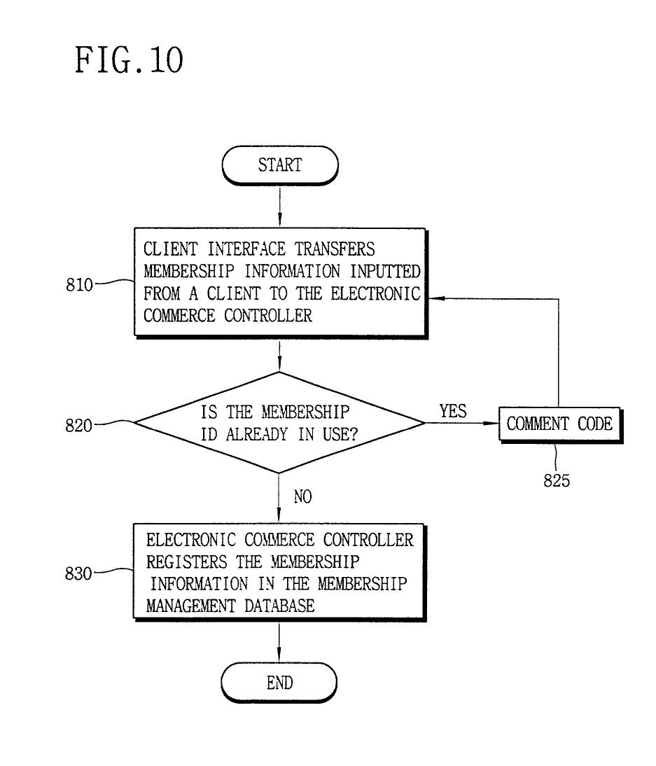

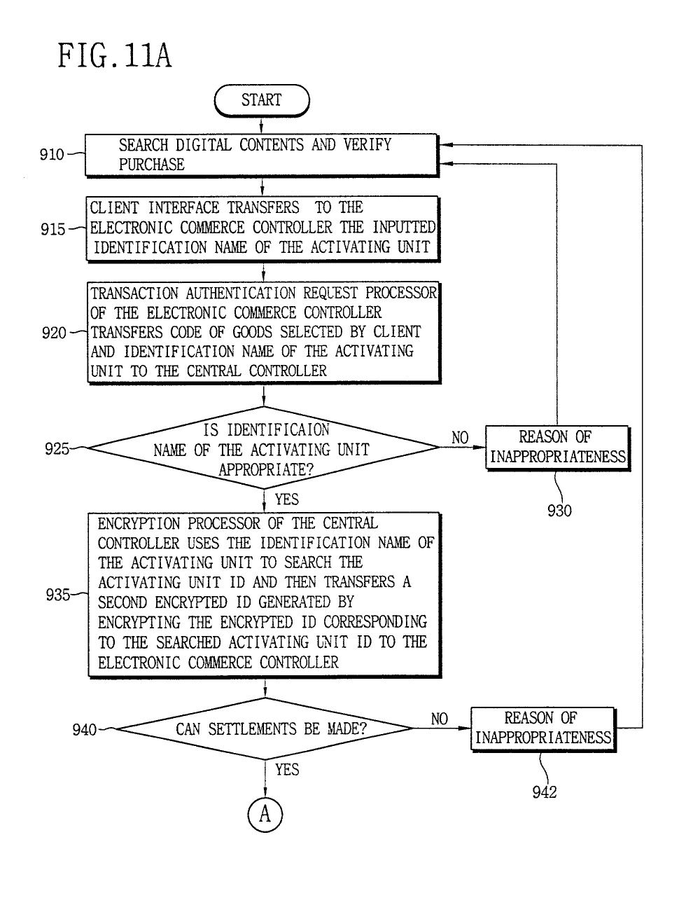

FIG. 10 is a flow chart for a case that a client is registered as a member who uses digital contents.

In FIG. 10, the client interface 400 transfers to the electronic commerce controller 600 membership information inputted from a client such as a membership ID, a name, a password, an address, a residing country, nationality, an e-mail address, birth date, and the like, regarding the member (Step 810).

The electronic commerce controller 600 searches the membership management database 665 by using the received membership ID and the like, and examines if the received membership ID is already in use (Step 820). If the membership ID is already in use, the electronic commerce controller 600 displays a comment code to the client (Step 825), returns to the screen for inputting membership information of the client (Step 810). Otherwise, if the membership ID is not in use, the electronic commerce controller 600 updates the membership management database 665 (Step 830).

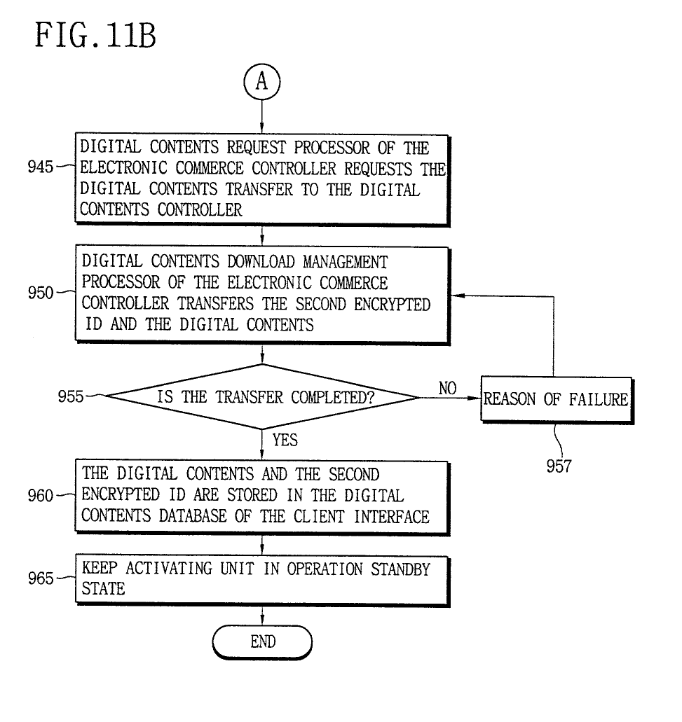

FIG. 11 is a flow chart for showing a transaction authentication according to a purchase of digital contents, that is, a generation of a second encrypted ID, and executions of downloading into the client interface 400. In FIG. 11, if a client searches digital contents in the client interface 400 and verifies a purchase (Step 910), the client interface 400 transfers to the electronic commerce controller 600 an identification name assigned to the activating unit which is inputted from the client (Step 915). If the transaction authentication request processor 630 of the electronic commerce controller 600 transfers a selected-by-client goods code and the inputted activating unit identification name to the central controller 200 for the transaction authentication (Step 920), the central controller 200 judges if the identification name of the activating unit is appropriate by using the activating unit database 250 (Step 925).

If inappropriate, the central controller 200 displays the inappropriate reason to the client (Step 930) and then returns to a screen of verifying the digital contents purchase (Step 910). Otherwise, if appropriate, the encryption processor 230 of the central controller 200 searches the activating unit database 250 by using the identification name of the activating unit, transfers to the electronic commerce controller 600 a second encrypted ID generated by encrypting an encrypted ID corresponding to the searched activating unit ID according to a predetermined second encryption algorithm (Step 935), and then requests settlement to the client (Step 940).

When the client pays with a credit card, data inputted from the client interface 400 such as the kind of card, card number, card expiry period, and the like, are transferred to an external settlement institution through the settlement request processor 635 of the electronic commerce controller 600.

If a notice is received from the external settlement institution that the settlement can not be made with the client' card, the central controller 200 displays an inappropriate reason (Step 942), returns to the step for the digital contents search and purchase verification (Step 910). Otherwise, if there is no problem in paying with the client's card, the digital contents request processor 642 of the electronic commerce controller 600 requests the digital contents transfer to the digital contents controller 300 (Step 945). The digital contents download management processor 645 of the electronic commerce controller 600 transfers the second encrypted ID and the digital contents to the client interface (Step 950).

The electronic commerce controller 600 examines whether the transfer is completed (Step 955). If failed, the electronic commerce controller 600 displays the failure reason (Step 957), and returns to the step for transferring the second encrypted ID and the digital contents (Step 950). Otherwise, if succeeded, the client interface 400 stores the digital contents and the second encrypted ID in the digital contents database 475 (Step 960), and the digital contents are in a driving standby state (Step 965).

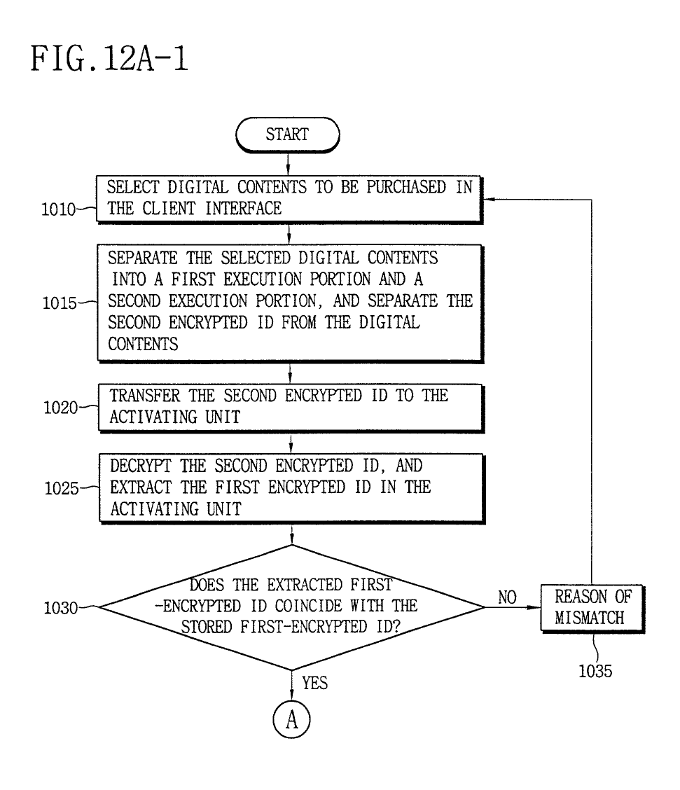

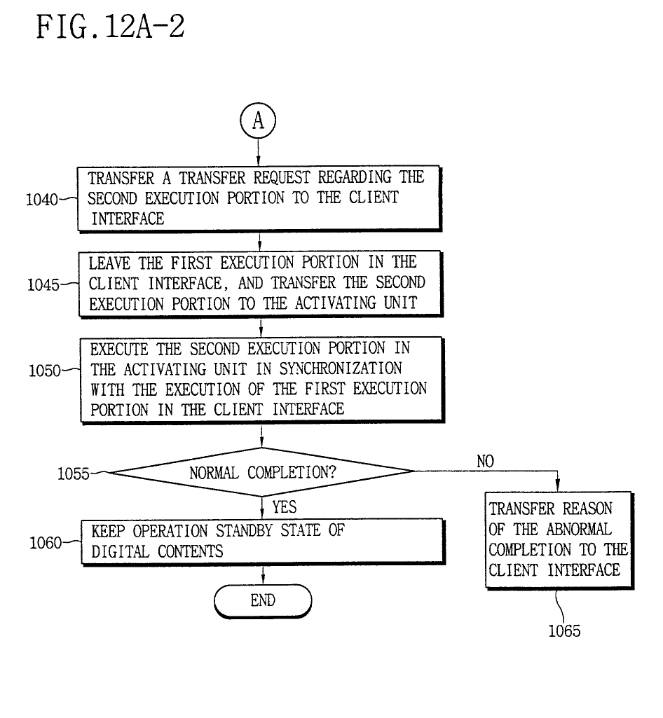

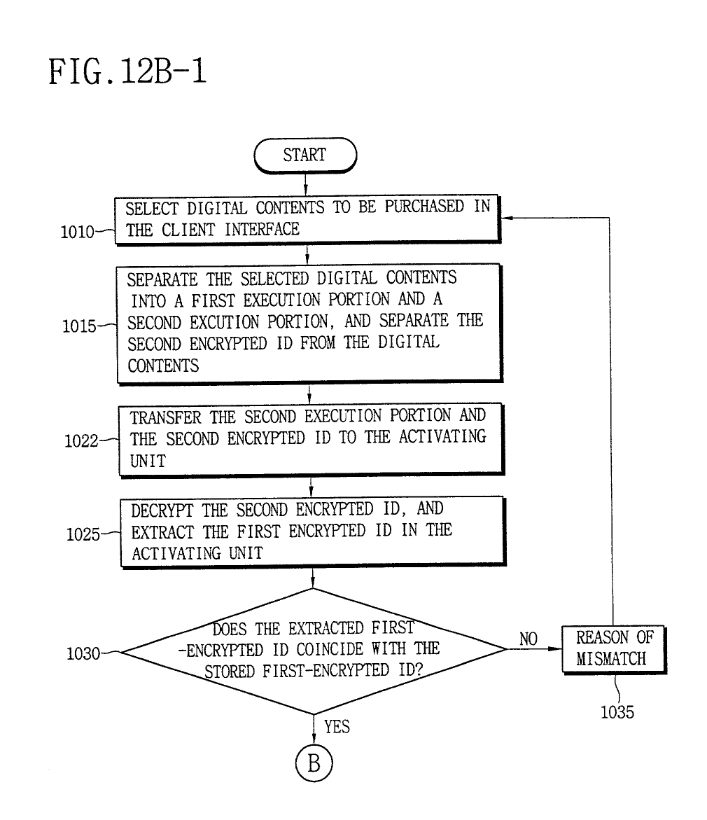

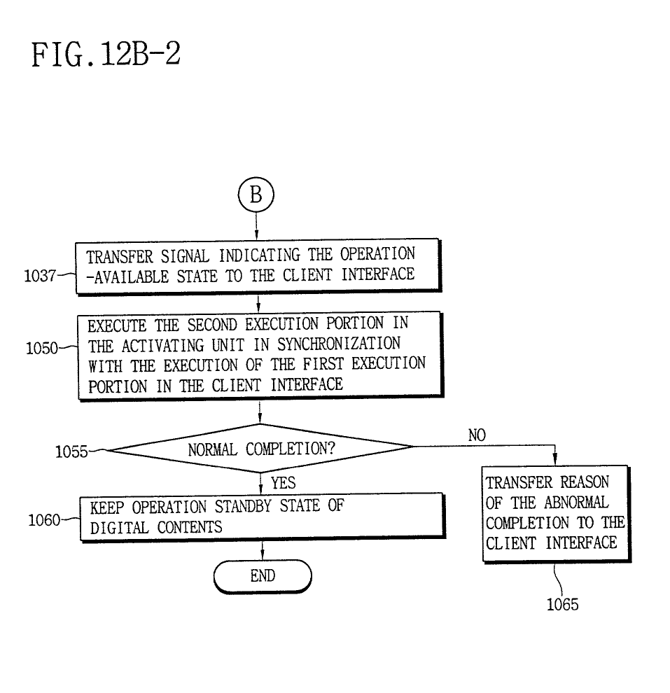

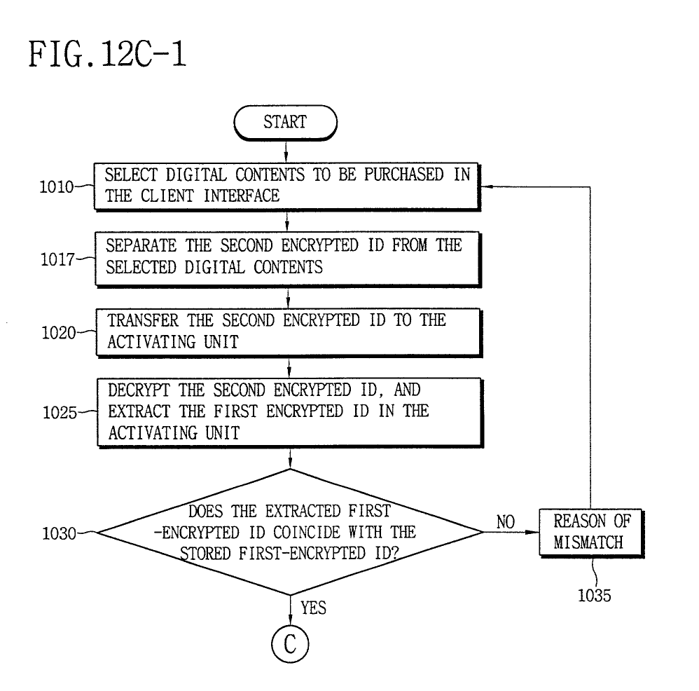

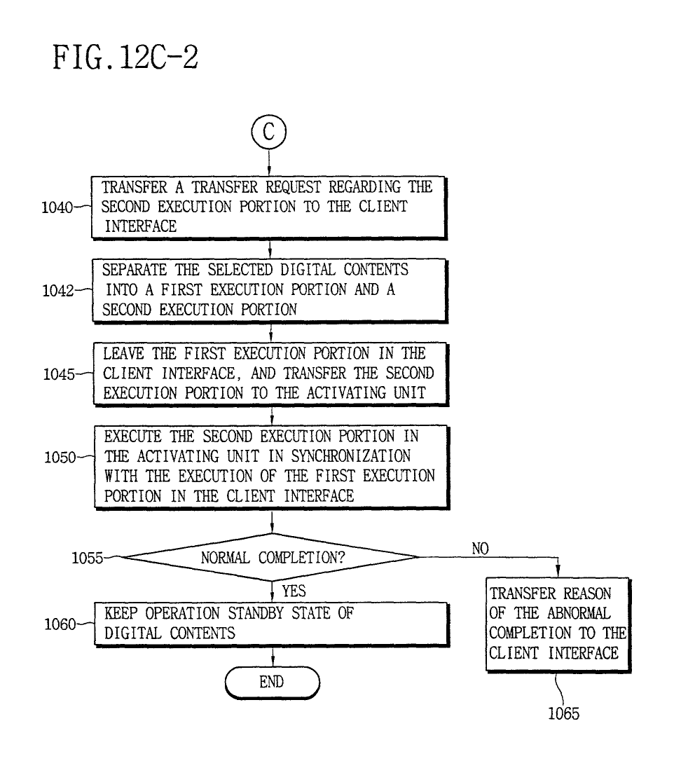

FIGS. 12a to 12c are flow charts for showing a process for driving digital contents, respectively.

In FIG. 12a to FIG. 12c, commonly, a client searches the purchased digital contents in the digital contents database 475 of the client interface 400 and selects the contents to be executed out of the purchased digital contents (Step 1010). If the client executes the digital contents, the client interface 400 and the activating unit 500, as described above, may be operated in three different forms.

Firstly, described with reference to FIG. 12a, the signal separation processor 455 of the client interface 400 separates the selected-by-client contents into a first execution portion to be executed in the client interface 400 and a second execution portion to be executed in the activating unit 500 at the same time with separating the second encrypted ID from the contents (Step 1015). The separated second-encrypted ID is transferred to the activating unit 500 through the communication processor 457 for communicating with the activating unit and the activating unit interface 490 (Step 1020). The activating unit 500 decrypts the transferred second-encrypted ID and extracts the first encrypted ID (Step 1025). The activating unit 500 compares the first-encrypted ID extracted by the decryption with the first encrypted ID kept in the encrypted ID database 580 thereof through the ID comparison processor 540 (Step 1030). If matched in the comparison step, it is judged as an operation-available state, so the activating unit 500 transfers a transfer request signal regarding the contents of the digital contents to be executed by its own, that is, the second execution portion to the client interface 400 (Step 1040). If not matched in the comparison result, it is considered that the digital contents are illegally reproduced or distributed, so a mismatch reason (operation-rejecting signal) is transferred to the client interface 400 and displayed (Step 1035), and then a contents selection (Step 1010) is reiterated.

If there is a transfer request with the contents of the digital contents from the activating unit 500, the client interface 400 leaves in the client interface 400 the first execution portion to be executed, and transfers to the activating unit 500 the second execution portion to be executed in the activating unit 500 (Step 1045).

Thereafter, the signal separation processor 455 of the client interface 400 interprets the first execution portion and executes the interpreted first execution portion through the video/audio drive 420 to the monitor 425 and the speaker 426. In synchronization with the above execution, the operation control processor 535 of the activating unit 500 interprets the received signals, so operation signals are executed through the driving unit 530 and sound signals are executed through the sound decoder 520 in the speaker 525 (Step 1050).

It is judged whether the execution is normally completed (Step 1055). If normally completed, an operation standby state of the digital contents (Step 1060) is made, and, if abnormally completed, an abnormal completion reason is transferred to the client interface and then displayed (Step 1065).

Secondly, described with reference to FIG. 12b, the signal separation processor 455 of the client interface 400 separates the selected-by-client contents into a first execution portion to be executed in the client interface 400 and a second execution portion to be executed in the activating unit 500 at the same time with separating the second encrypted ID from the digital contents (Step 1015). The separated second execution portion and the second encrypted ID are transferred to the activating unit 500 through the communication processor 457 for communicating with the activating unit and the activating interface 490 (Step 1022). The activating unit 500 decrypts the transferred second-encrypted ID and extracts the first encrypted ID (Step 1025). Thereafter, the activating unit 500 compares the first encrypted ID extracted by the decryption with the first encrypted ID kept in the encrypted ID database 580 thereof through the ID comparison processor 540 (Step 1030). If matched in the comparison step, it is judged as an operation-available state, so a signal indicating the operation-available state is transferred to the client interface 400 (Step 1037). If not matched in the comparison result, the digital contents are considered to be illegally reproduced or distributed, so a mismatch reason (operation-rejecting signal) is transferred to the client interface 400 and displayed (Step 1035), and then the contents selection (Step 1010) is reiterated.

In response to the signal indicating the operation-available state from the activating unit 500, the signal separation processor 455 of the client interface 400 interprets the first execution portion and executes the interpreted first execution portion through the video/audio drive 420 in the monitor 425 and the speaker 426. In synchronization with the execution, the operation control processor 535 of the activating unit 500 interprets the received second execution portion, so operation signals are executed through the driving unit 530 and sound signals are executed through the sound decoder 520 in the speaker 525 (Step 1050).

It is judged that the execution is normally completed (Step 1055). If normally completed, an operation standby state (Step 1060) of the digital contents is made, and, if abnormally completed, an abnormal completion reason is transferred to the client interface and then displayed (Step 1065).

Thirdly, described with reference to FIG. 12c, the signal separation processor 455 of the client interface 400 separates the second encrypted ID from the digital contents selected by a client (Step 1017). The separated second-encrypted ID is transferred to the activating unit 500 through the communication processor 457 for communicating with the activating unit and the activating interface 490 (Step 1020). The activating unit 500 decrypts the transferred second-encrypted ID and extracts the first encrypted ID (Step 1025). Thereafter, the activating unit 500 compares the first encrypted ID extracted by the decryption with the first encrypted ID kept in the encrypted ID database 580 thereof through the ID comparison processor 540 (Step 1030). If matched in the comparison step, it is judged as an operation-available state, so the activating unit 500 transfers to the client interface 400 a transfer request signal with respect to the second execution portion, that is, the contents of the digital contents to be executed by its own (Step 1040). If not matched in the comparison result, it is judged that the digital contents are considered to be illegally reproduced or distributed, so a mismatch reason (operation-rejecting signal) is transferred to the client interface 400 and then displayed (Step 1035). Thereafter the contents selection (Step 1010) is reiterated.

If there is a transfer request with respect to the contents of the digital contents from the activating unit 500, the signal separation processor 455 of the client interface 400 separates the selected-by-client contents into a first execution portion to be executed in the client interface 400 and a second execution portion to be executed in the activating unit 500 (Step 1042). Thereafter, the first execution portion to be executed in the client interface 400 is left in the client interface 400 and the second execution portion to be executed in the activating unit 500 is transferred to the activating unit 500 (Step 1045).

The signal separation processor 455 of the client interface 400 interprets the first execution portion, and the interpreted first execution portion is executed through the video/audio drive 420 in the monitor 425 and the speaker 426. In synchronization with the execution, the operation control processor 535 of the activating unit 500 interprets the received signal, so operation signals are executed through the driving unit 530 and sound signals are executed through the sound decoder 520 in the speaker 525 (Step 1050).

It is judged whether the execution is normally completed (Step 1055). If normally completed, an operation standby state (Step 1060) of the digital contents is made. If abnormally completed, an abnormal completion reason is transferred to the client interface and then displayed (Step 1065).

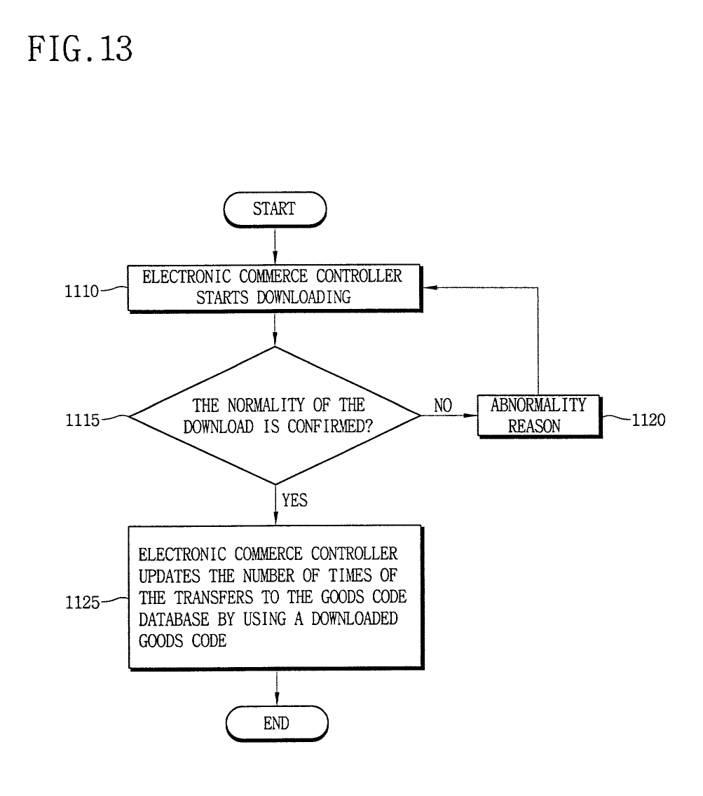

FIG. 13 is a flow chart for registering the number of times of downloading of digital contents in a database. In FIG. 13, the digital contents download management processor 645 of the electronic commerce controller 600 starts transferring by a request of a client (Step 1110) and examines whether the transfer is normally completed (Step 1115).

If the download is abnormally completed, an abnormality reason is displayed on a download screen (Step 1120) and then the step 1110 is reiterated. If the download is normally completed, the electronic commerce controller 600 updates the number of times of the transfers (charges information on a member) to the goods code database 660 by using a downloaded goods code (Step 1125).

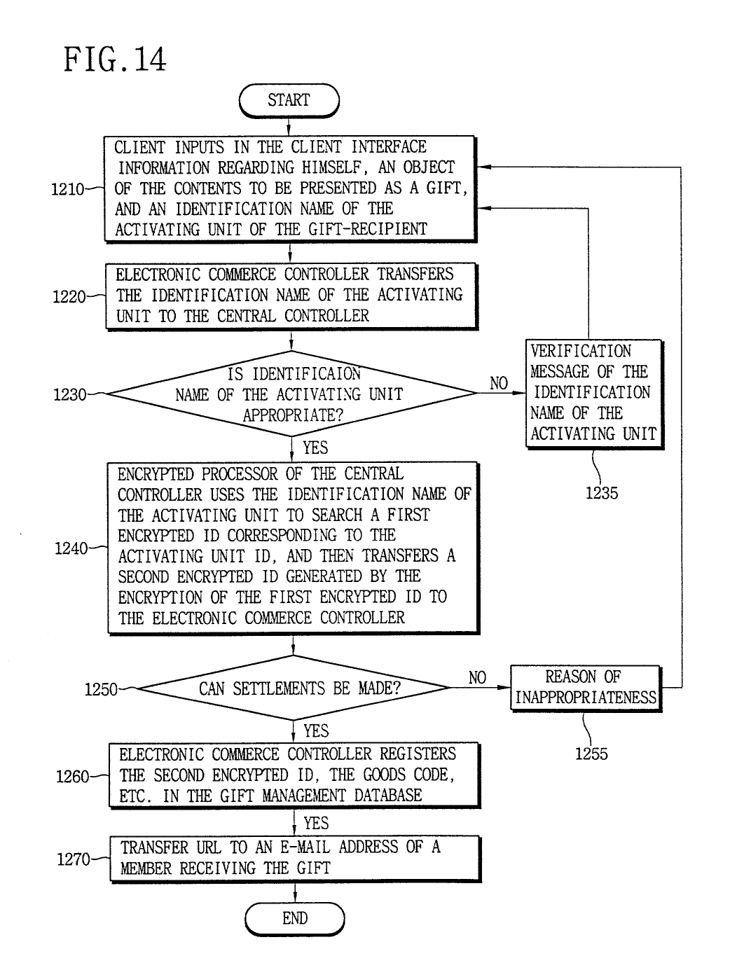

FIG. 14 is a flow chart for showing a process for presenting digital contents as a gift. In FIG. 14, a client who wishes to present inputs gift-recipient information including data relating to himself an object of the contents to be presented, and an identification name of an activating unit of the present receiver (Step 1210).

The transaction authentication request processor 630 of the electronic commerce controller 600 transfers to the central controller 200 the identification name of an activating unit of a person to receive a gift of the client for a transaction authentication (Step 1220), the central controller 200 judges whether is the identification name of the activating unit is appropriate by using the activating unit database 250 (Step 1230).

If judged as inappropriate, a verification message of the identification name of the activating unit is displayed to the client interface 400 (Step 1235) and the step for inputting the identification name of the activating unit (Step 1210) is reiterated. If judged as appropriate, the encryption processor 230 of the central controller 200 searches a first encrypted ID corresponding to the activating unit ID from the activating unit database 250 by using the identification name of the activating unit, generates a second encrypted ID by encrypting the first encrypted ID according to a predetermined second encryption algorithm stored in the encryption algorithm database 245, and transfers the second encrypted ID to the electronic commerce controller 600. The electronic commerce controller 600 stores the second encrypted ID in the gifts management database 675 (Step 1240) and then request settlement to the client (Step 1250).

When the client pays with a credit card, data such as the kind of the credit card, card number, card expiration date, and the like, which is inputted from the client interface 400, is transferred to an external settlement institution through the settlement request processor 635 of the electronic commerce controller 600.

If a notice is received from the external settlement institution that the settlement can not be made with the card of the client, an inappropriate reason is displayed (Step 1255) and then the step for inputting the selection of the contents to be purchased in the client interface 400, the identification name of the activating unit of the gift-recipient, and the like is reiterated (Step 1210). If there is no problem in the settlement with the client's card, the gifts management processor 638 of the electronic commerce controller 600 stores in the gifts management database 675 the membership ID of the gift sender, the identification name of the activating unit of the gift recipient, the transaction authentication code of goods to be presented, the goods code to be presented, and the like (Step 1260), and then transfers an URL to an email address of a member who is to receive the gift (Step 1270).

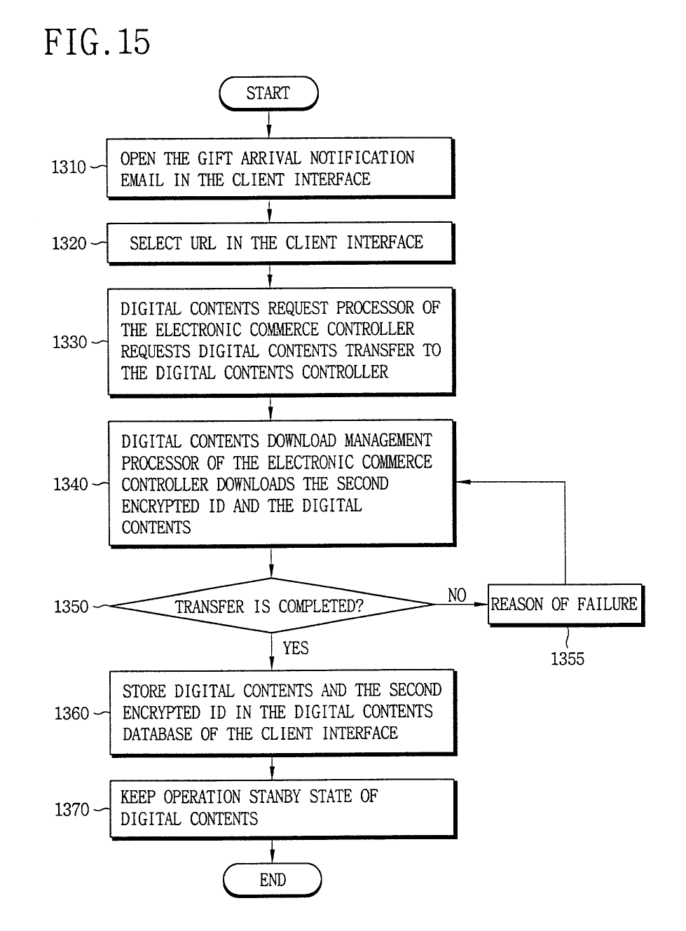

FIG. 15 is a flow chart for showing a process for downloading the digital contents to be presented as a gift. If a gift arrival notification email is read by the client in the client interface 400 (Step 1310), the client selects the URL in which the goods to be presented exists, in order to download the digital contents (Step 1320).

The digital contents request processor 642 of the electronic commerce controller 600 requests a digital contents transfer to the digital contents controller 300 (Step 1330).

The digital contents download management processor 645 of the electronic commerce controller 600 transfers the second encrypted ID and the digital contents searched in the gifts management database 675 to the client interface (Step 1340).

The electronic commerce controller 600 examines whether the transfer is normally completed (Step 1350). If the transfer is not normally completed, a failure reason is displayed (Step 1355) and then the step for transferring the second encrypted ID and the digital contents (Step 1340) is reiterated. If the transfer is normally completed, the client interface 400 stores the second contents and the second encrypted ID in the digital contents database 475 (Step 1360) and then waits for the execution of the digital contents (Step 1370). After this, the driving process of the presented digital contents is the same as the flow charts shown in FIG. 12a to FIG. 12c.

[Second Aspect of the First Embodiment]

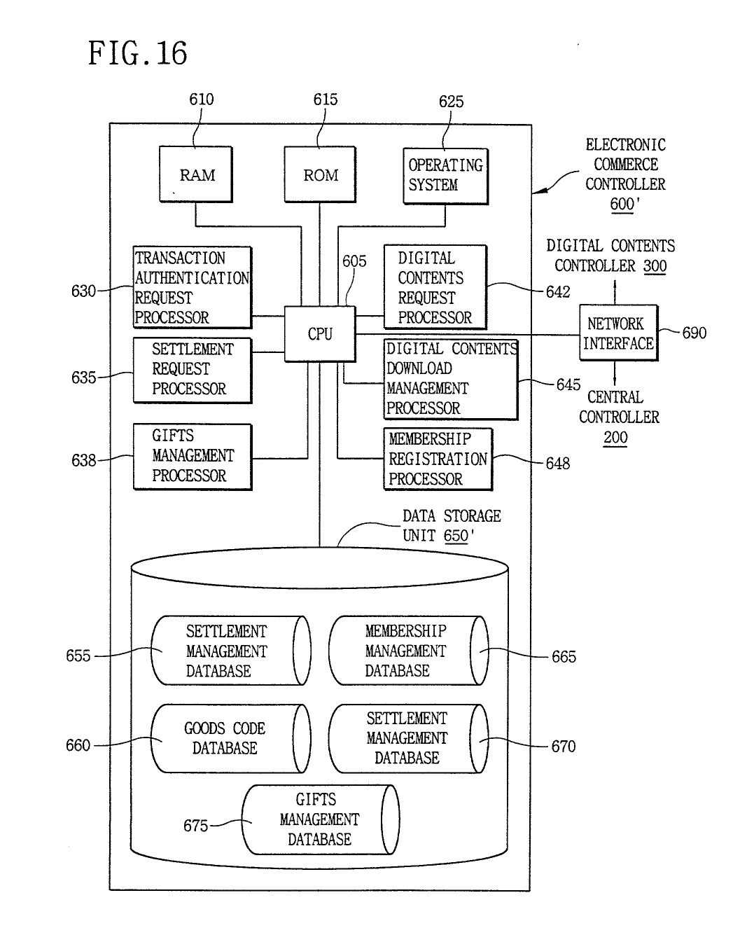

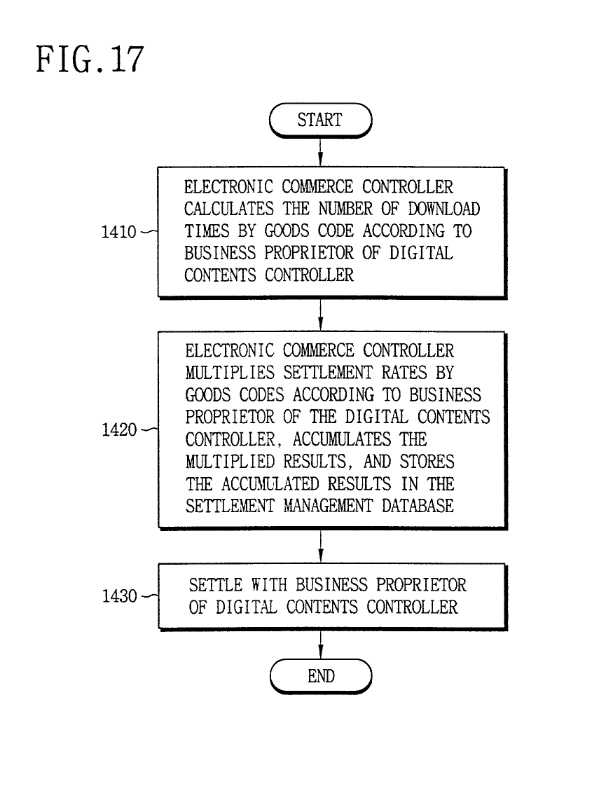

Next, the operations of the second aspect that a main business proprietor runs and manages the central controller 200 and the electronic commerce controller 600′ (refer to FIG. 16) and another business proprietor runs the digital contents controller 300 through direct or outsourcing manufactures of the digital contents by using the basic structure according to the first embodiment of the present invention, as shown in FIG. 2, will be described in more detail with reference to FIG. 16 and FIG. 17.

Since the second aspect is basically the same as FIG. 4 to FIG. 15 relating to the first aspect and the descriptions to the drawings, only different points from the first aspect will be described for simplification.

Differently from the first aspect that the same business proprietor runs and manages the central controller 200, the electronic commerce controller 600, and the digital contents controller, settlement matters may occur in case that a main business proprietor runs the central controller 200 and the electronic commerce controller 600′ and another business proprietor runs the digital contents controller 300. FIG. 16 and FIG. 17 are associated with the settlement matters.

FIG. 16 is a block diagram for showing a structure of the electronic commerce controller 600′ employed in the second aspect of the present invention. As shown in FIG. 16, the data storage unit 650′ of the electronic commerce controller 600′ further comprises a settlement management database 670, compared to the data storage unit 650 of the electronic commerce controller 600 employed in the first aspect. The settlement management database 670 is a database for managing settlements with the proprietor of the digital contents controller 300, which manages an ID of the digital contents controller 300, settlement dates, settlement amounts, and the like.

FIG. 17 is a flow chart for showing settlements by proprietor of digital contents controller 300 according to the second aspect. In FIG. 17, the electronic commerce controller 600′ calculates the number of transfer times by goods codes according to a proprietor of the digital contents controller 300 by using data of the goods code database 660 (Step 1410), multiplies settlement rates decided between the main business proprietor and the proprietor of the controller 300, accumulates the calculation results, and stores the accumulated results in the settlement management database 670 (Step 1420). By using the data, the main business proprietor who runs the central controller 200 and the electronic commerce controller 600′ makes settlements with the business proprietor who runs the digital contents controller 300 (Step 1430).

[Third Aspect of the First Embodiment]

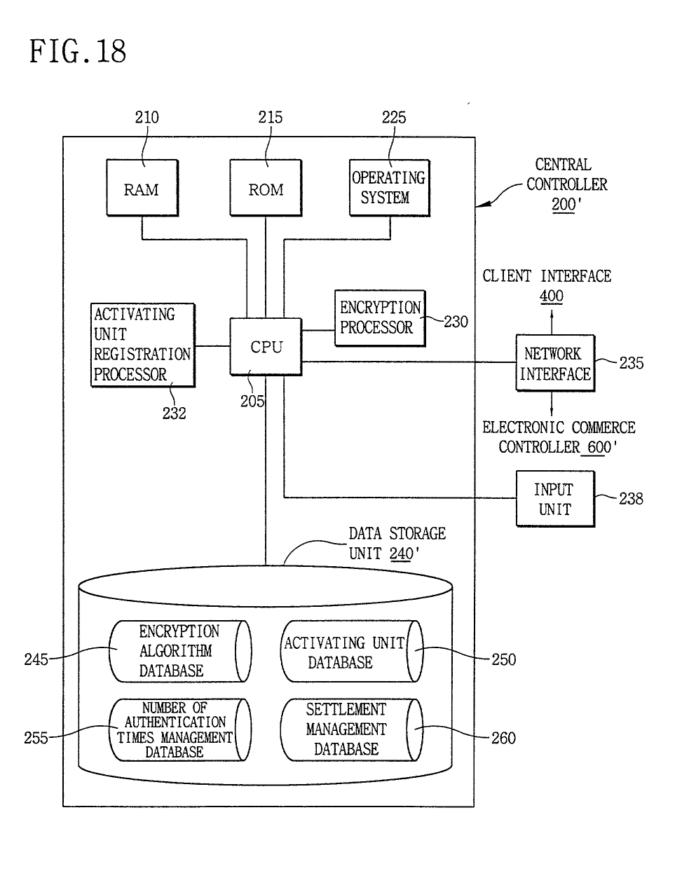

Next, the operations of the third aspect that a main business proprietor runs the central controller 200′ and another business proprietor runs the electronic commerce controller 600′ (refer to FIG. 16) and the digital contents controller 300 through direct or outsourcing manufactures of the digital contents by using the basic structure according to the first embodiment of the present invention, as shown in FIG. 2, will be described in more detail with reference to FIG. 18 to FIG. 20.

Since the third aspect is basically the same as FIG. 4 to FIG. 15 and description thereof regarding the first aspect and FIG. 16 and FIG. 17 and description thereof regarding the second aspect, different points from the first and second aspects will be described for the simplification of the description. Differently from the first aspect that the same business proprietor runs and manages the central controller 200, the electronic commerce controller 600, and the digital contents controller, settlement matters may occur between the business proprietors even in case that a main business proprietor runs the central controller 200 and another business proprietor runs the electronic commerce 600′ and the digital contents controller 300. FIG. 18 to FIG. 20 are associated with such settlement matters.

FIG. 18 is a block diagram for showing a structure of a central controller 200′ employed in a third aspect. The structure indicated as a reference numeral 600′ of FIG. 16 is employed as the electronic commerce controller.

The data storage unit 240′ of the central controller 200′ shown in FIG. 18 further comprises the number of authentication times management database 255 and the settlement management database 260, compared to the data storage unit 240 of the central controller 200 employed in the first and second aspects. Authentication times management database 255 is a database for managing goods codes, business proprietor IDs, the number of authentication times, and the like, and the settlement management database 260 is a database for managing settlement contents with business proprietors, which includes business proprietor IDs, settlement dates, settlement amounts, and the like.

The settlement management database 670 of the data storage unit 650′ of the electronic commerce controller 600′ shown in FIG. 16, becomes a database, in the third aspect, for managing the settlement contents between the business proprietor of the digital contents controller 300 and a main business proprietor who runs the central controller 200′, which manages digital contents controller IDs, settlement dates with the business proprietor of the digital contents controller, settlement amounts with the business proprietor of the digital contents controller, settlement dates with the main business proprietor, settlement amounts with the main business proprietor, and the like.

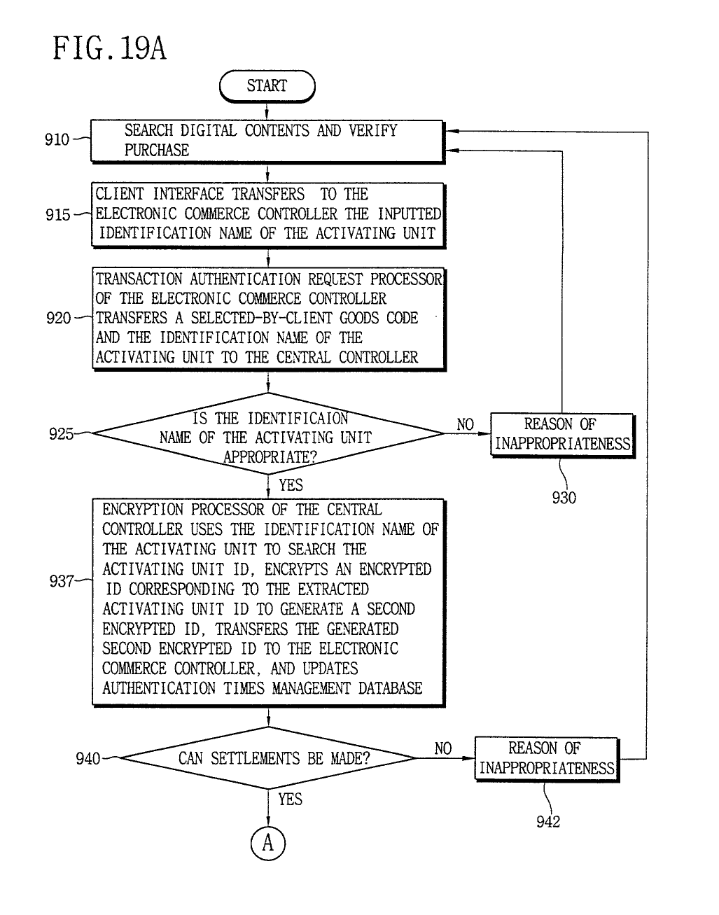

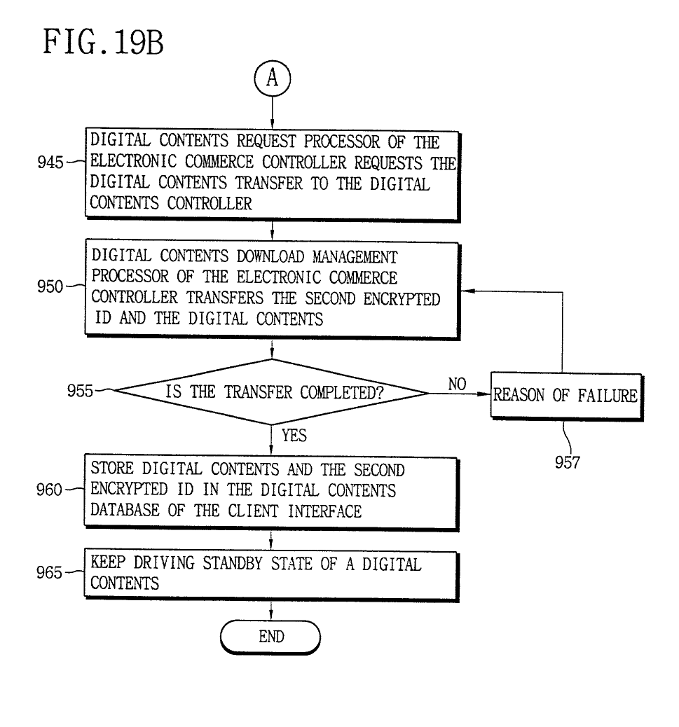

FIG. 19 is a flow chart for showing a transaction authentication according to a purchase of digital contents, that is, a generation of a second encrypted ID and the execution of downloading into a client interface 400 according to a third aspect. FIG. 19 is the same as FIG. 11 except that the step 935 in FIG. 11 is changed to the step 937, based on the structure of the central controller 200′ according to the third aspect.

In FIG. 19, as described in FIG. 11, if a client searches digital contents in the client database 400 and verifies a purchase (Step 910), the client interface 400 transfers to the electronic commerce controller 600′ an identification name assigned to an activating unit which is inputted from the client (Step 915). If the transaction authentication request processor 630 of the electronic commerce controller 600′ transfers to the central controller 200′ a goods code chosen by the client and an inputted identification name of an activating unit for a transaction authentication (Step 920), the central controller 200′ judges the appropriateness of the identification name of the activating unit by using the activating unit database 250 (Step 925).

If judged as inappropriate, the inappropriateness reason is displayed to the client (Step 930) and then a screen for verifying the purchase of the digital contents is reiterated (Step 910). Otherwise, if judged as appropriate, the encryption processor 230 of the central controller 200′ searches the activating unit database 250 by using the identification name of the activating unit to extract an activating unit ID corresponding to the identification name, and transfers to the electronic commerce controller 600′ a second encrypted ID generated by encrypting an encrypted ID corresponding to the extracted activating unit ID according to a predetermined second encryption algorithm, and updates authentication times management database 255 (Step 937). Thereafter, settlements are requested to the client (Step 940).

When the client pays with a credit card, data such as the kind of the card, card number, card expiry period, and the like, inputted from the client interface 400 is transferred to an external settlement institution through the settlement request processor 635 of the electronic commerce controller 600.

If a notice is made from the external settlement institution that the settlements can not be made with the client's card, an inappropriateness reason is displayed (Step 942) and then the step for the digital contents searches and the purchase verification is reiterated (Step 910). Otherwise, if there is no problem in settling with the client's card, the digital contents request processor 642 of the electronic commerce controller 600′ requests the transfer of the digital contents to the digital contents controller 300 (Step 945). The digital contents download management processor 645 of the electronic commerce controller 600′ transfers the second encrypted ID and the digital contents to the client interface 400 (Step 950).

The electronic commerce controller 600′ examines whether the transfer is completed (Step 955). If failed, the failure reason is displayed (Step 957) and then the step for transferring the second encrypted ID and the digital contents is reiterated (Step 950). Otherwise, if successful, the client interface 400 stores the digital contents and the second encrypted ID in the digital contents database 475 (Step 960) and the driving standby state of the digital contents is kept (Step 965).

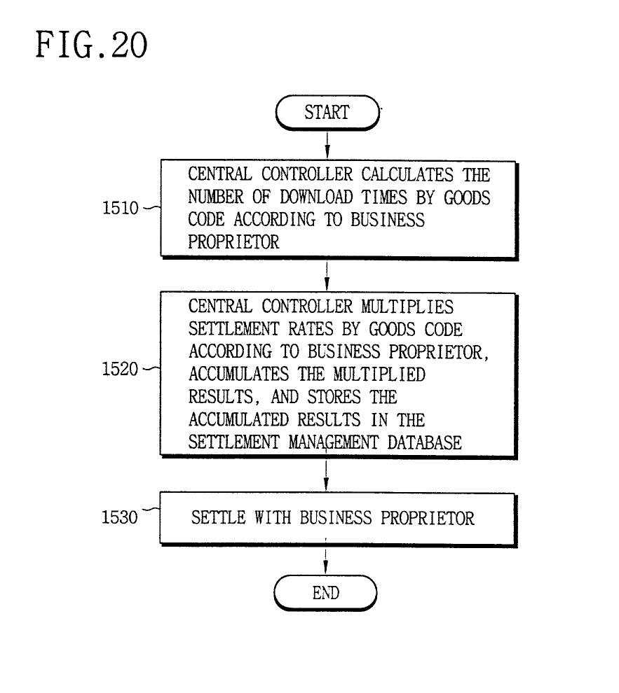

FIG. 20 is a flow chart for showing settlements by the business proprietor who simultaneously runs the digital contents controller 300 and the electronic commerce controller 600′ according to the third aspect. In FIG. 20, the central controller 200′ calculates the number of transfer times by goods code according to business proprietors by using data of authentication times management database 255 (Step 1510), multiplies settlements ratio with the calculation, accumulates the multiplied calculation, and stores the accumulated result in the settlement management database 260 (Step 1520). The settlements with the business proprietors are made by using the data (Step 1530).

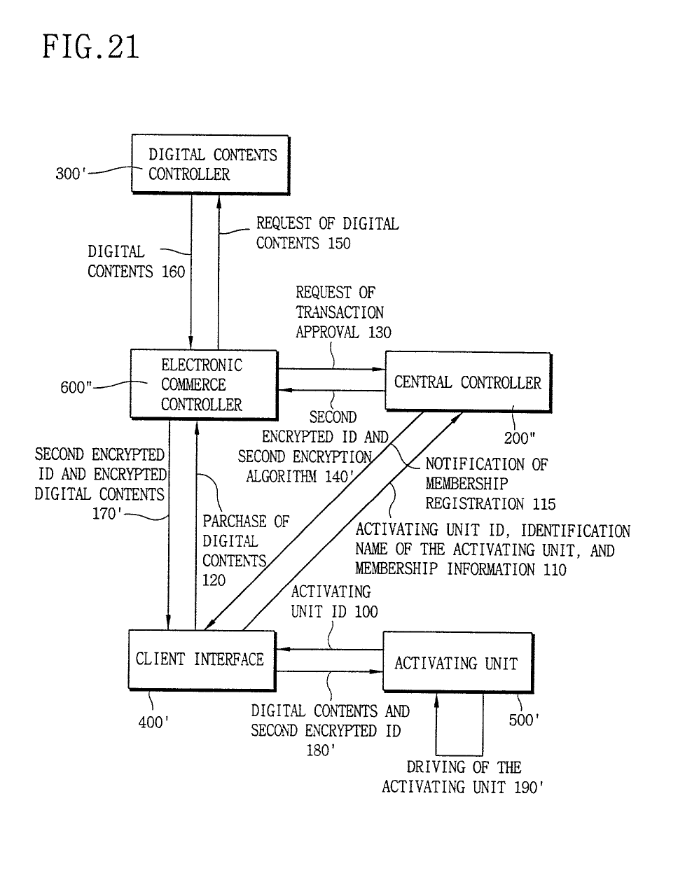

In order to apply the present invention with respect to digital contents which are not separated into the first execution portion to be executed in the client interface and the second execution portion to be executed in the activating unit, a second embodiment of the present invention will be described with reference to FIG. 21 to FIG. 27.

The same constituents of FIG. 21 to FIG. 26 as those in the first embodiment are indicated as the same reference numerals, similar constituents are distinguished by using (′) and (″ ), and the same constituents are referred to the description of the first embodiment to avoid repeated descriptions.

FIG. 21 is a view for explaining a basic structure and a control flow for preventing illegal reproductions/distributions of digital goods by use of physical goods according to the second embodiment of the present invention.

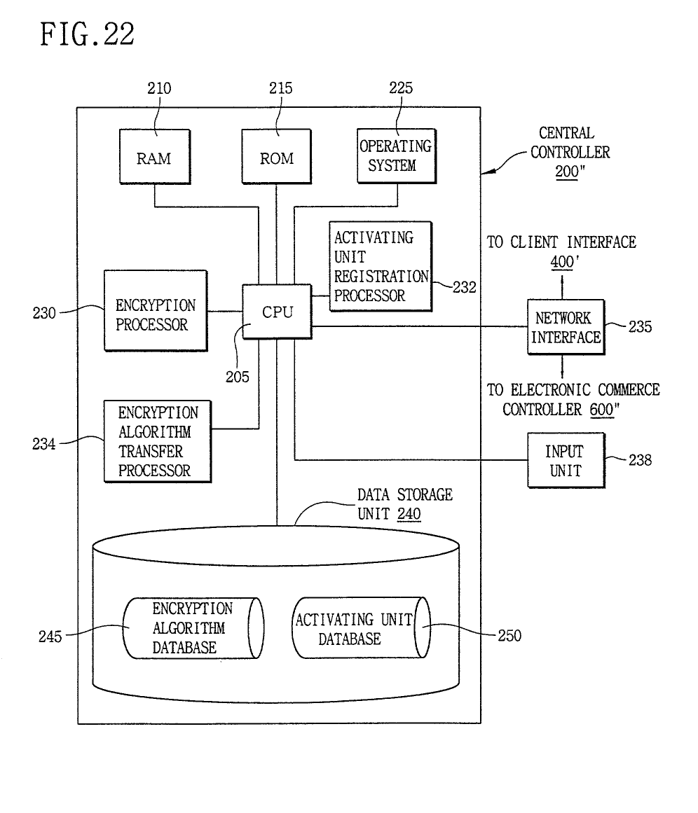

FIG. 22 is a block diagram for showing a central controller 200′ employed in a second embodiment of the present invention. The different points from the first embodiment are that the second embodiment further includes an encryption algorithm transfer processor for transferring a second encryption algorithm to an electronic commerce controller 600′ and the central controller 200′ is connected to the client interface 400 and the electronic commerce controller 600″.

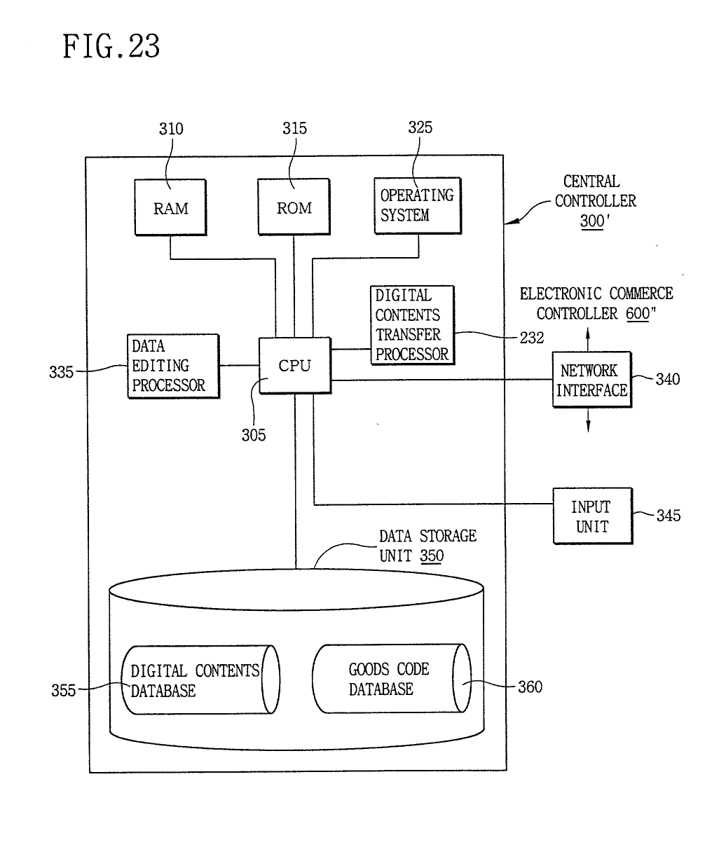

FIG. 23 is a block diagram for showing a digital contents controller 300′ employed in the second embodiment of the present invention, internal structure constituents are the same as in the first embodiment, but the connection to the electronic commerce controller 600″ is different from the first embodiment.

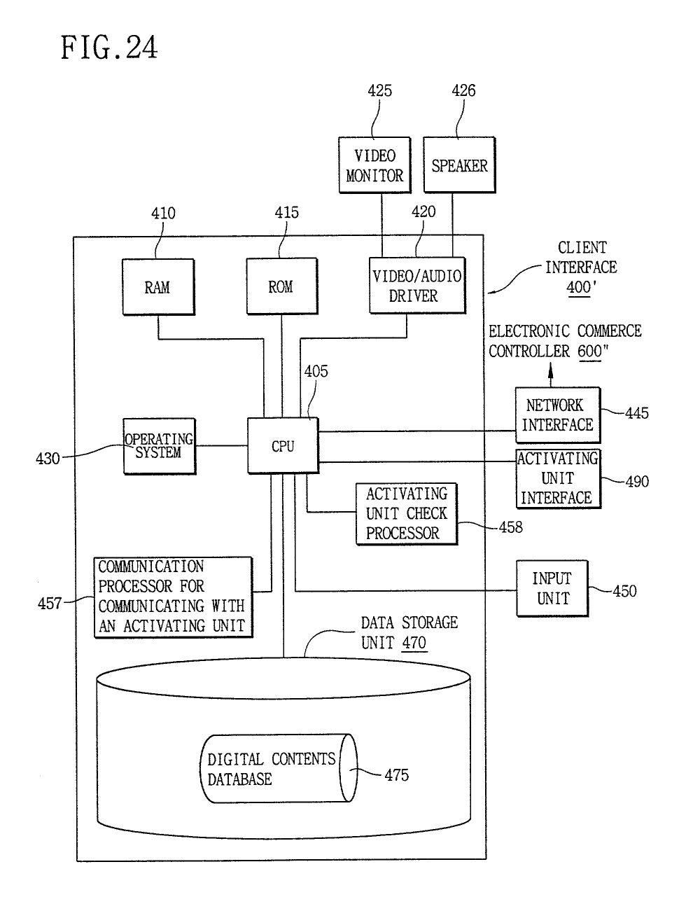

FIG. 24 is a block diagram for showing a client interface 400′ employed in the second embodiment of the present invention, which is different from the first embodiment in that the signal separation processor 455 of the first embodiment is not provided and the client interface 400′ is connected to the electronic commerce controller 600″.

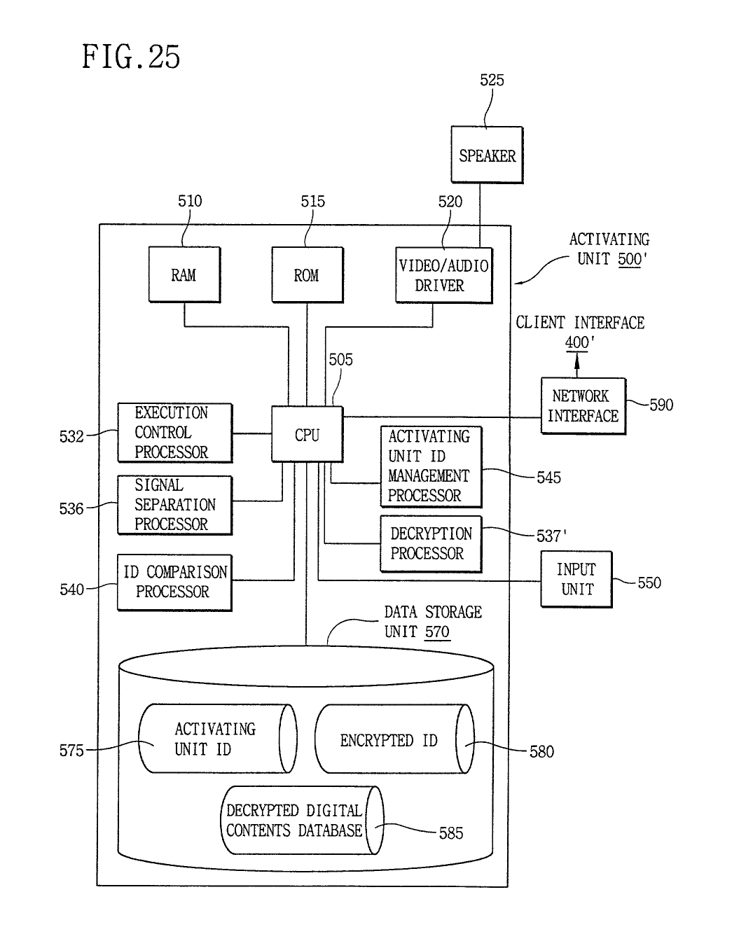

FIG. 25 is a block diagram for showing an activating unit 500′ employed in the second embodiment, which is different from the first embodiment in that the driving unit 530 and the operation control processor 535 of the first embodiment are not provided, a signal separation processor 536 for separating encrypted digital contents and a second encrypted ID and a decrypted digital contents database 585 are further included, and the activating unit 500′ is connected to the client interface 400′.

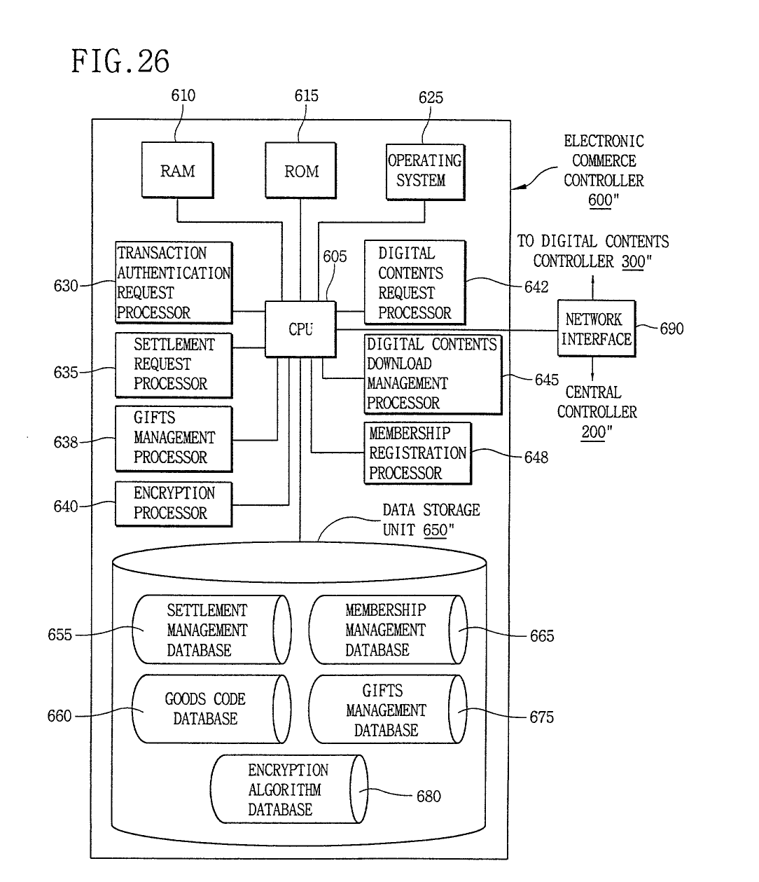

FIG. 26 is a block diagram for showing the electronic commerce controller 600″ employed in the second embodiment, which is different from the first embodiment in that an encryption processor 640 for encrypting digital contents according to the second encryption algorithm and an encryption algorithm database 680 for storing the second encryption algorithm transferred from the central controller 200″ are further included and the digital contents controller 300′ and the central controller 200″ are connected to the electronic commerce controller 600″.

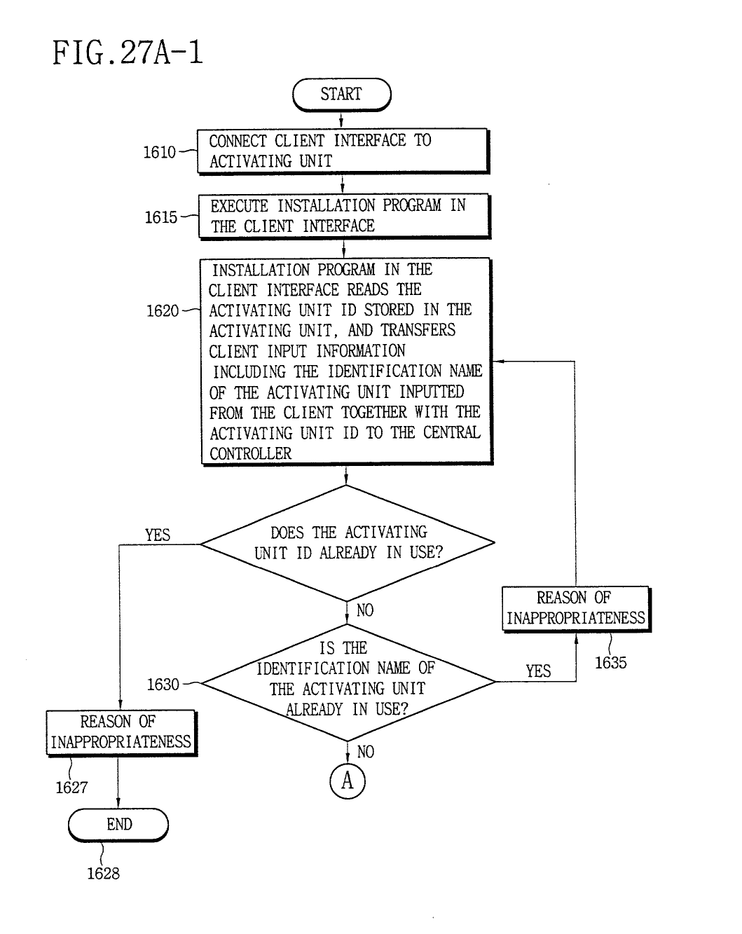

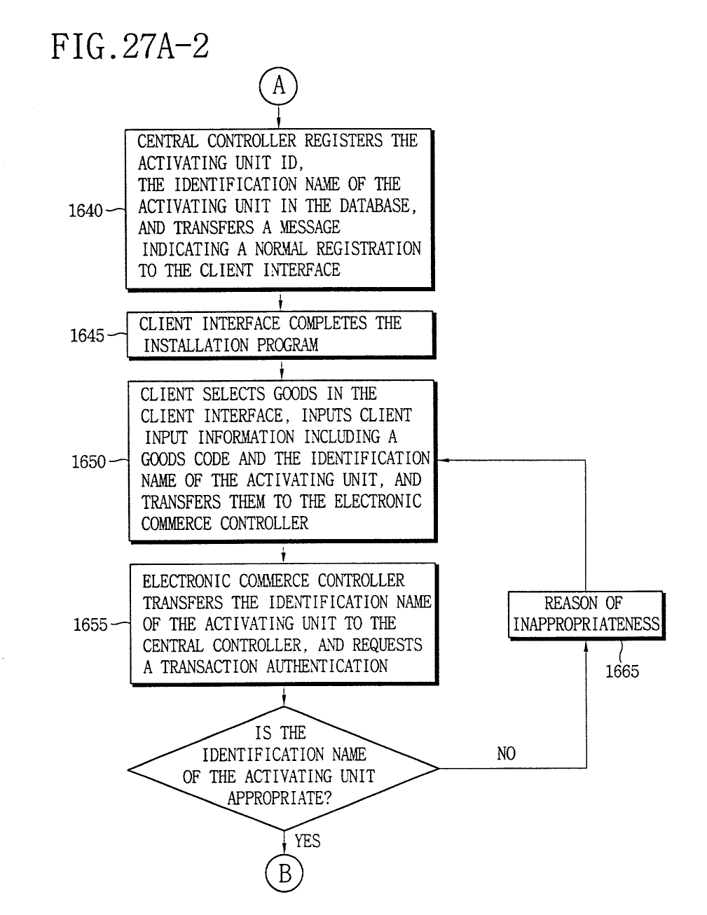

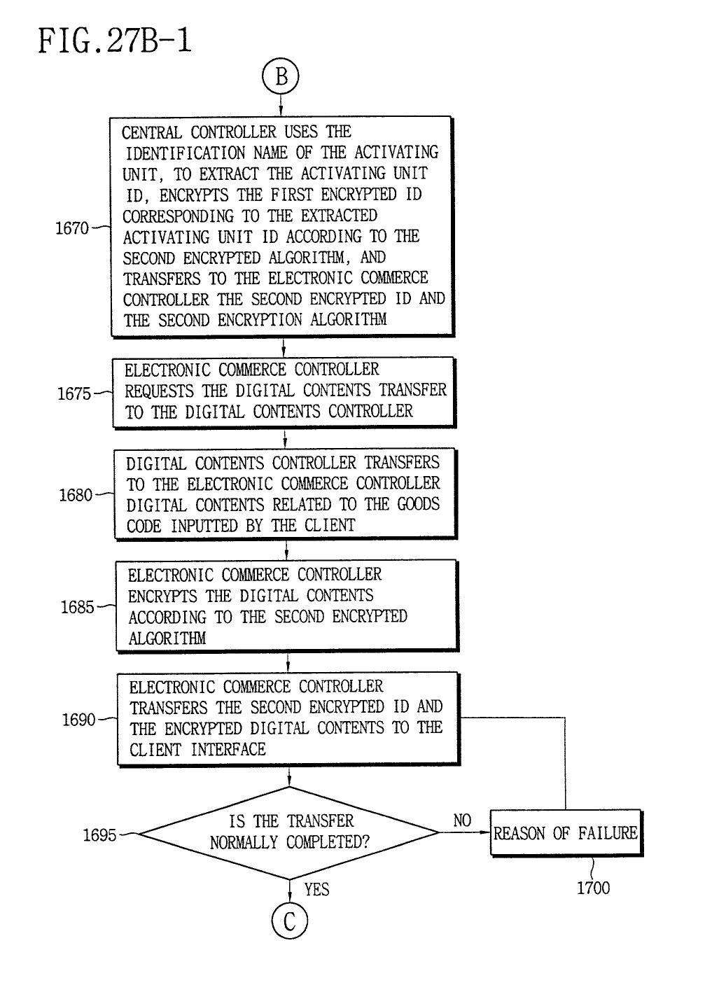

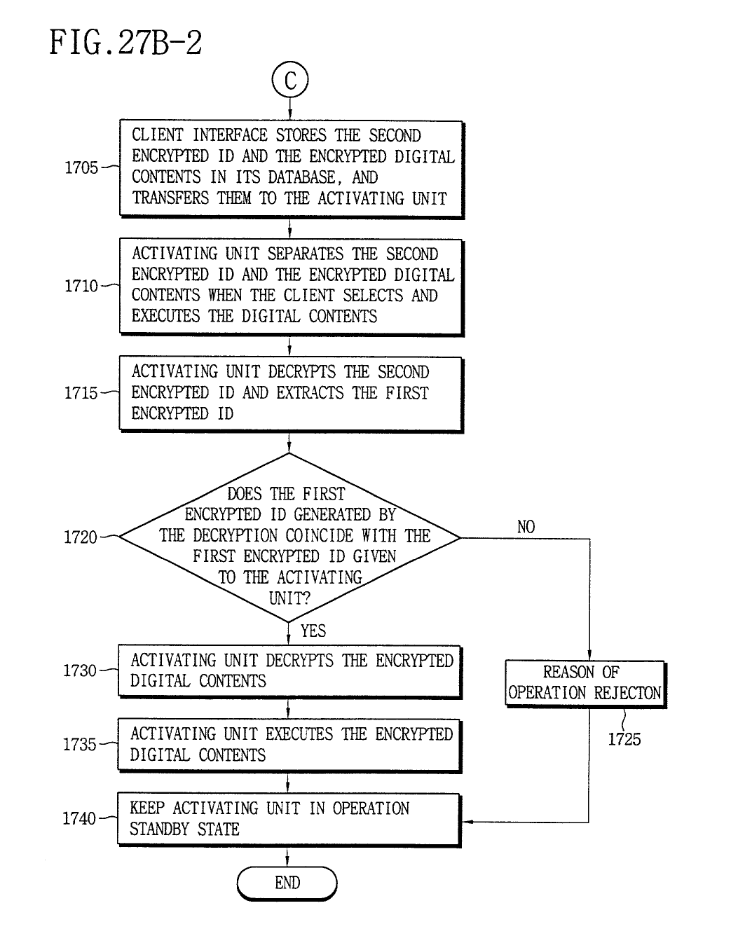

FIG. 27a and FIG. 27b are a flow chart for showing in detail the control flow for preventing illegal reproductions/distributions of digital goods by use of physical goods according to the second embodiment of the present invention, which indicate one flow from the start to the end about the most preferable examples, differently from the description of the first embodiment describing separately primary steps.

First, with reference to FIG. 21, the basic structure and the control flow according to the second embodiment of the present invention are described for preventing illegal reproductions/distributions of digital goods by use of physical goods.

As in FIG. 2 for the first embodiment, if an installation program provided together with an activating unit or downloaded from a web site is installed to the client interface 400′ after a connection of the purchased activating unit 500 to the client interface 400′, the installation program automatically takes in an activating unit ID 100 within the activating unit 500′ or requests an input of the activating unit ID. The activating unit ID is, upon the production of the activating unit 500, an ID inherently given to every activating unit, which is recorded in the activating unit or known to a purchaser in a tag form outside the activating unit. The client interface 400′ may be an unattended vendor for selling digital goods. In this case, a client inputs an activating unit ID known in a tag form outside the activating unit. A manufacturer records in an activating unit a first encrypted ID encrypted according to a predetermined first encryption algorithm before letting it out to the market by using an activating unit ID.

The activating unit ID, an identification name of the activating unit assigned by the client, and membership information are transferred to the central controller 200″. The central controller 200″ examines whether the identification name of the activating unit is already in use by another client. If the identification name assigned by the client is not in use, data regarding the activating unit is produced in an activating unit database by using the transferred information, and a notice of the new registration fact is made to the client of the client interface 400′ (Step 115).

In case that the client has registered in advance the assigned-by-client identification name of the activating unit to the central controller 200″ based on the activating ID, the assigned-by-client identification name of the activating unit, and membership information, the step for the new registration to the central controller 200″ is not requested.

In case that the client requests the contents he wishes to purchase through the client interface 400′ (Step 120), the assigned-by-client identification name of the activating unit which is inputted in the client interface 400′, and a goods code are transferred to the electronic commerce controller 600″.

The electronic commerce controller 600″ transfers a goods code of the selected-by-client digital goods and the assigned-by-client identification name of the activating unit to the central controller 200″ and requests a transaction authentication (Step 130). The central controller 200″, when there is the transaction authentication request, searches the activating unit ID and the first encrypted ID corresponding to the activating unit ID in the activating unit database by using the transferred assigned-by-client identification name of the activating unit, transfers a second encrypted ID generated by encrypting the first encrypted ID according to a predetermined second encryption algorithm and the second encryption algorithm to the electronic commerce controller 600″ (Step 140′), and forms charges information with respect to the corresponding client based on membership information corresponding to the goods code and the assigned-by-client identification name.

The electronic commerce controller 600″, if the transaction is approved by the central controller 200″, that is, if the second encrypted ID and the second encryption algorithm are transferred, stores the second encrypted ID and the second encryption algorithm, and requests to the digital contents controller 300′ the digital contents the client wishes to purchase (150). According to the digital contents request (Step 150) from the electronic commerce controller 600″, the digital contents controller 300′ transfers the corresponding digital contents to the electronic commerce controller 600″ (Step 160). The electronic commerce controller 600″, if the requested digital contents are transferred from the digital contents controller 300′, encrypts the digital contents according to the second encryption algorithm, and transfers the encrypted digital contents and the second encrypted ID associated with the encrypted digital contents to the client interface 400′ (Step 170′). In encrypting the digital contents, the name of the digital contents and the like can be excluded.

The client interface 400′ stores in the digital contents database 475 the received second encrypted ID and the encrypted digital contents in preparation for the case that the activating unit 500′ is not properly connected or the case that the digital contents stored in the activating unit is lost, and transfers the encrypted digital contents and the second encrypted ID to the activating unit 500′. Even though the encrypted digital contents are stored in a database in the client interface 400′ or illegally reproduced or distributed to a client interface of another client, the digital contents can not be executed since the digital contents does not have the decryption algorithm corresponding to the second encryption algorithm.

The activating unit 500′ receiving the encrypted digital contents and the second encrypted ID can be executed in various aspects as below.

Firstly, the second encrypted ID and the encrypted digital contents are separated, the second encrypted ID is decrypted according to a decryption algorithm corresponding to the second encryption algorithm, and the decrypted first-encrypted ID is compared with the first encrypted ID kept in the memory of the activating unit. If matched in the comparison result, the encrypted digital contents is also decrypted according to the decryption algorithm, the decrypted digital contents are stored in the database within the activating unit 500′, and then the decrypted digital contents are executed in the activating unit (Step 190). If not matched in the comparison result, the digital contents are considered to be illegally reproduced or distributed, and an operation-rejecting signal is outputted.

Secondly, the encrypted digital contents and the second encrypted ID are decrypted according to the decryption algorithm corresponding to the second encryption algorithm, and then the digital contents and the decrypted first-encrypted ID are separated. Thereafter, the decrypted first-encrypted ID is compared with the first encrypted ID kept in the memory of its own. If matched in the comparison result, the decrypted digital contents are stored in the database within the activating unit 500′, and then the decrypted digital contents are executed in the activating unit (Step 190). If not matched in the comparison result, the digital contents are considered to be illegally reproduced or distributed, to thereby output an operation-rejecting signal.

Hereinafter, detailed descriptions will be made about FIG. 27a and FIG. 27b with reference to FIG. 21 to FIG. 26.

In order to record activating unit information in the activating unit database 250 of the central controller 200″ after the purchase of the activating unit 500′, if the client connects the activating unit 500′ to the client interface 400′ (Step 1610) and an installation program for the activating unit is executed in the client interface 400′ (Step 1615), the activating unit check processor 458 of the client interface 400′ reads the activating unit ID of the activating unit 500′, and the activating unit ID is transferred to the central controller 200″ together with client input information including the identification name of the activating unit inputted from the client (Step 1620). In the step 1620, in case that the activating unit ID is known to the client in a tag form outside the activating unit, the activating unit ID is also included in the client input information.

The central controller 200″ searches the activating unit database 250 and examines whether the activating unit ID is already in use (Step 1625). The existence of the activating unit ID means that the activating unit is duplicated, so a comment code of such meaning is displayed on the monitor 425 of the client interface 400′ (Step 1627), and the installation program of the activating unit is completed (Step 1628). If the same activating unit ID does not exist, the central controller 200″ examines whether the identification name assigned to the activating unit is already in use (Step 1630). The existence of the identification name of the activating unit means that another member uses the identification name, so a comment code of the meaning is displayed on the monitor 425 of the client interface 400′ (Step 1635). Thereafter, the screen for inputting the identification name of the activating unit and the like is displayed, and a new identification name of the activating unit is again transferred to the central controller 200″ (Step 1620).

If the same identification name does not exist, the central controller 200″ registers the identification name newly assigned to the activating unit and the like to the activating unit database 250, transfers to the client interface 400′ a message indicating a normal registration (Step 1640), and completes the installation program of the activating unit (Step 1645).

Thereafter, the client searches the digital contents in the client interface 400′, selects goods, and inputs client input information including a goods code corresponding to the selected goods and the identification name of the activating unit. The client interface 400′ transfers the client input information to the electronic commerce controller 600″ (Step 1650).

If the transaction authentication request processor 630 of the electronic commerce controller 600 transfers to the central controller 200 the client input information including the goods code selected by the client and the identification name of the activating unit for a transaction authentication (Step 1655), the central controller 200″ judges the appropriateness of the identification name of the activating unit by using the activating unit database 250 (Step 1660).

If judged as inappropriate, the inappropriateness reason is displayed to the client (Step 1665), and the step 1650 is reiterated for inputting the client input information including the selection of the digital contents and the identification name of the activating unit. Otherwise, if judged as appropriate, the encryption processor 230 of the central controller 200″ searches the activating unit database 250 by using the identification name of the activating unit to extract an activating unit ID corresponding to the identification name, extracts a first encrypted ID corresponding to the extracted activating unit ID, and extracts from the encryption algorithm database 245 a second encryption algorithm corresponding to the extracted first-encrypted ID.

Thereafter, the central controller 200″ transfers to the electronic commerce controller 600″ the second encrypted ID generated by encrypting the first encrypted ID according to the second encryption algorithm and the extracted second encryption algorithm, and the electronic commerce controller 600″ stores the second encryption algorithm in the encryption algorithm database 680 (Step 1670).

The electronic commerce controller 600″, if the second encryption algorithm and the second encrypted ID are received, transfers the goods code inputted in the step 1650 to the digital contents controller 300′ and requests the transfer of the digital contents corresponding to the goods code (Step 1675).

If the digital contents controller 300′ receives the goods code, the digital contents controller 300′ searches the digital contents database 355 and transfers the searched digital contents to the electronic commerce controller 600″ (Step 1680).

The electronic commerce controller 600″ encrypts the received digital contents according to the second encryption algorithm through the encryption processor 640 (Step 1685), and transfers the encrypted digital contents and the second encrypted ID to the client interface 400′ (Step 1690).

It is judged that the transfer is normally completed (Step 1695). If not normally completed, the failure reason is displayed on the monitor 425 of the client interface (Step 1700) and the step 1690 is reiterated. If normally completed, the client interface 400′ stores in the digital contents database 475 the second encrypted ID and the encrypted digital contents and transfers the same to the activating unit 500′ (Step 1705).

Once the second encrypted ID and the encrypted digital contents are transferred to the activating unit 500′, the activating unit can be diversely operated as stated above. The example is described through the step 1710 and the step 1735.

The activating unit 500′, first, separates the second encrypted ID and the encrypted digital contents through the signal separation processor 536 (Step 1710). Next, the activating unit 500′ decrypts the second encrypted ID into the first encrypted ID according to the decryption algorithm which corresponds to the second encryption algorithm and is stored in the encrypted ID section thereof 580 (Step 1715), and compares the first encrypted ID generated by the decryption with the first encrypted ID kept in the activating unit ID section 575 thereof (Step 1720). If matched in a comparison result, the encrypted digital contents are decrypted according to the decryption algorithm (Step 1730), the decrypted digital contents are stored in the decrypted digital contents database 585 in the activating unit 500′, the decrypted digital contents are executed in the activating unit 500′ according to the control of the execution control unit 532 (Step 1735), the activating unit 500′ stays in an operation standby state (Step 1740). If not matched in the comparison result, the digital contents are considered to be illegally reproduced or distributed, so an operation-rejecting signal is outputted (Step 1725) and the activating unit 500′ stays in an operation standby state (Step 1740).

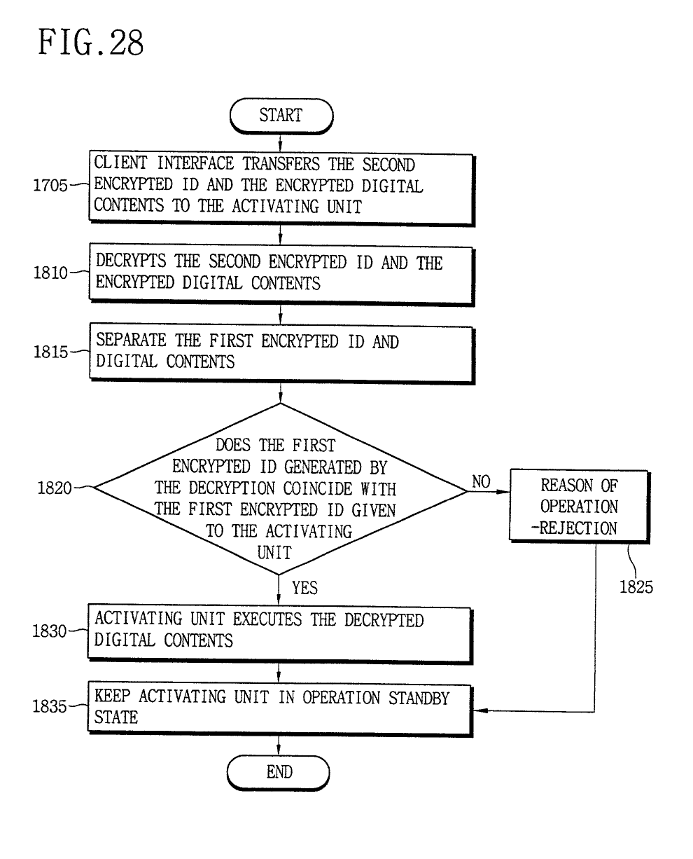

FIG. 28 is a flow chart for showing a different aspect for steps 1710 to 1740 with respect to operations of an activating unit of FIG. 27b. Describing another aspect of the activating unit of the second embodiment by using FIG. 28, first, in the step 1705 of FIG. 27b, if the client interface 400′ transfers the second encrypted ID and the encrypted digital contents to the activating unit 500′, differently from the aspect of the activating unit shown in FIG. 27b, the second aspect decrypts the encrypted digital contents and the second encrypted ID according to the decryption algorithm corresponding to the second encryption algorithm and stored in the encrypted ID section 580 of the activating unit 500′ and extracts the digital contents and the first encrypted ID (Step 1810), and the activating unit 500′ separates the decrypted digital contents and the first encrypted ID through the signal separation processor 536. Thereafter, the first encrypted ID generated by the decryption is compared with the first encrypted ID kept in the activating unit ID part 575 of section of the activating unit 500′ (Step 1820). If matched in a comparison result, the decrypted digital contents are stored in the decrypted digital contents database 585 within the activating unit 500′, the decrypted digital contents are executed in the activating unit 500′ according to the control of the execution control unit 532 (Step 1830), and the activating unit 500′ stays in an operation standby state (Step 1830). If not matched in the comparison result, the digital contents are considered to be illegally reproduced or distributed, an operation-rejecting signal is outputted (Step 1825), and the activating unit 500′ stays in the operation standby state (Step 1835).

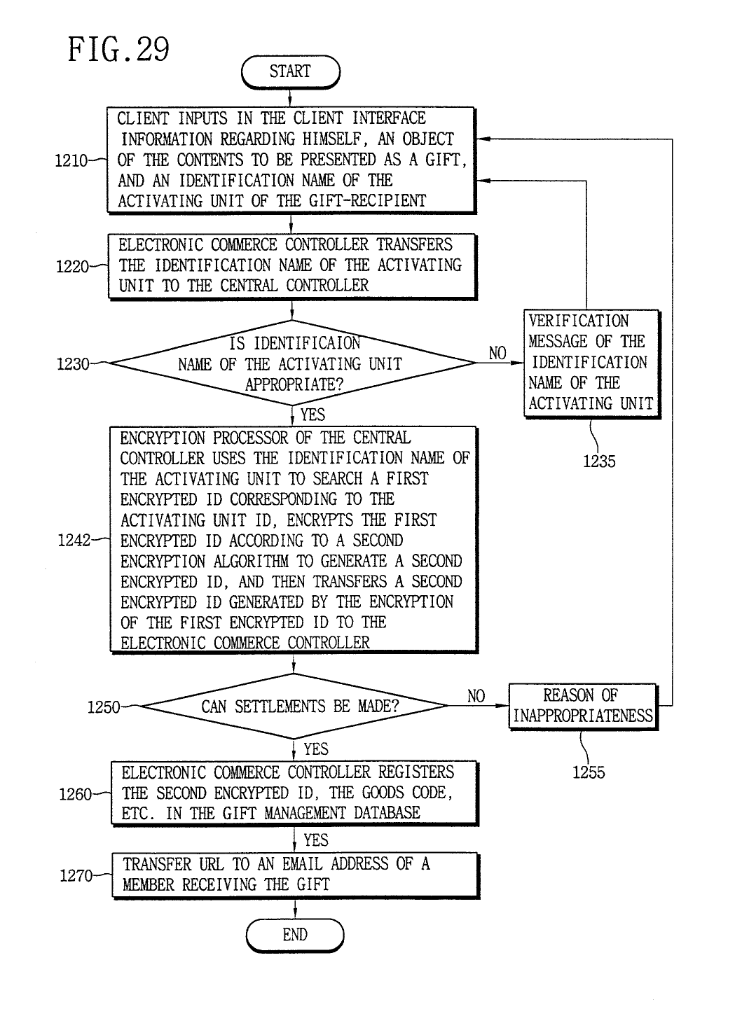

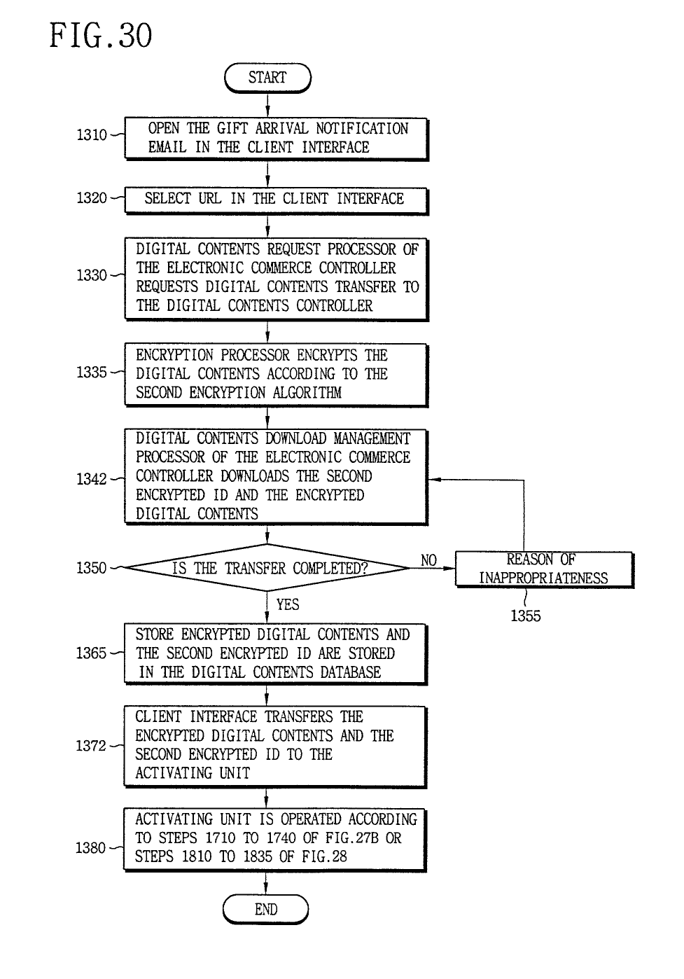

Next, the giving and taking of a gift of digital contents according to the second embodiment of the present invention will be described with reference to FIG. 29 and FIG. 30. The same step numbers are employed with respect to the same steps as FIG. 14 and FIG. 15 in the first embodiment.

FIG. 29 is a flow chart for showing a process for giving a gift of digital contents in the second embodiment.

In FIG. 29, a client who wishes to give a gift inputs in the client interface 400′ gift-recipient information including data regarding himself, an object of digital contents to be presented, an identification name of an activating unit of the gift-recipient (Step 1210).

If the transaction authentication request processor 630 of the electronic commerce controller 600″ transfers the identification name of the activating unit of the gift-recipient to the central controller 200″ for a transaction authentication (Step 1220), the central controller 200″ judges the appropriateness of the identification name of the activating unit by using the activating unit database 250 (Step 1230).

If judged as inappropriate, a message for verifying the identification name of the activating unit is displayed to the client interface 400′ (Step 1235) and then the step for inputting the identification name of the activating unit is reiterated (Step 1210). If judged as appropriate, the encryption processor 230 of the central controller 200″ searches the first encrypted ID corresponding to the activating unit ID in the activating unit database 250 by using the identification name of the activating unit. If the encryption algorithm transfer processor 234 transfers to the electronic commerce controller 600″ a second encrypted ID generated by the encrypting the first encrypted ID according to a predetermined second encryption algorithm stored in the encryption algorithm database 245, the electronic commerce controller 600″ stores the second encrypted ID in the gifts management database 675 and the second encryption algorithm in the encryption algorithm database 680 (Step 1242). Thereafter, settlements are requested to the client (Step 1250).

When a client pays with a credit card, data such as the kind of the card, card number, card expiry date, and the like inputted from the client interface 400′ is transferred to an external settlement institution through the settlement request processor 635 of the electronic commerce controller 600″.

If a notice is received from the external settlement institution that the settlement can not be made with the card, the inappropriateness reason is displayed (Step 1255), and the step for inputting the selection of contents to be purchased, the identification name of the activating unit of the gift recipient, and the like in the client interface 400′ is reiterated (Step 1210). If there is no problem in settling with the client's card, the gifts management processor 638 of the electronic commerce controller 600″ registers in the gifts management database 675 a membership ID of the gift-sender, the identification name of the activating unit of the gift-recipient, a transaction authentication code of goods to be presented, a goods code to be presented, and the like (Step 1260) and transfers an URL to an email address of the gift recipient (Step 1270).

FIG. 30 is a flow chart for showing a process of downloading digital contents to be presented as a gift in the second embodiment. If the client interface 400′ opens a gift arrival notification mail (Step 1310), the client selects the URL of the goods to be presented in order to download the digital contents (Step 1320).

The digital contents request processor 642 of the electronic commerce controller 600″ requests the transfer of the digital contents to the digital contents controller 300′ (Step 1330).

If the digital contents are transferred, the encryption processor 640 of the electronic commerce controller 600″ encrypts the digital contents according to the second encryption algorithm stored in the encryption algorithm database 680 (Step 1335). Thereafter, the digital contents download management processor 645 of the electronic commerce controller 600″ transfers to the client interface 400′ the second encrypted ID searched from the gifts management database 675 and the encrypted digital contents (Step 1342).

The electronic commerce controller 600″ judges whether the transfer is normally completed (Step 1350). If the transfer is not normally completed, the failure reason is displayed (Step 1355), and the step (Step 1342) for transferring the second encrypted ID and the encrypted digital contents is reiterated. If the transfer is normally transferred, the client interface 400′ stores in the digital contents database the encrypted digital contents and the second encrypted ID (Step 1365) and transfers the same to the activating unit 500′ (Step 1372).

Thereafter, the activating unit 500′ of the digital contents to be presented operates according to the steps 1710 to 1740 of FIG. 27b or the steps 1810 to 1835 of FIG. 28 (Step 1380).

As stated above, the present invention prevents illegal reproductions/distributions of digital contents by use of an apparatus operating with digital contents downloaded from a user computer.

That is, through a mechanism of using an activating unit ID exposed to a client for an input of the client or recorded in the activating unit, a first encrypted ID generated by encrypting the activating unit ID according to a predetermined first encryption algorithm, an identification name assigned to the activating unit, and a second encrypted ID generated by encrypting the first encrypted ID according to a predetermined second encryption algorithm when a registered identification name and an inputted identification name are matched upon purchase of the digital contents including purchase of a gift, illegal reproductions/distributions of digital contents and activating units can be prevented by, upon purchasing digital contents, encrypting the first encrypted ID according to the predetermined second encryption algorithm and transferring the second encrypted ID together with the digital contents or the first encrypted ID according to the predetermined second algorithm as well as encrypting the digital contents according to the second encryption algorithm and transferring the second encrypted ID and the encrypted digital contents, upon executing the digital contents, extracting the first encrypted ID through decryption of the second encrypted ID, comparing the extracted first-encrypted ID with a first encrypted ID stored in the activating unit, and executing the digital contents in the activating unit if the two first encrypted IDs are matched.

Further, according to the present invention, since the illegal reproductions/distributions of the digital contents are basically prevented, accurate settlements can be made with external digital contents providers, and even physical goods manufacturers can be participated in the digital contents flow and profit sharing. By giving a certain role to physical goods in which the digital contents are executed, it becomes possible to block the illegal reproductions/distributions of the digital goods as well as to purchase the digital goods as a gift.

What is claimed is:

1. An apparatus for preventing reproduction/distribution of digital goods by use of physical goods, comprising: a digital goods section including digital goods to be sold via online from a business proprietor to a client;
a physical goods to be operated by contents of the digital goods, the physical goods having an inherent ID given thereto, a first encrypted ID also given thereto and encrypted according to a first encryption algorithm from said inherent ID, and an assignable identification name for identifying the physical goods;
a controller for examining whether or not the client is a genuine proprietor of the physical goods based on information including the assignable identification name and the inherent ID of the physical goods, generating a second encrypted ID by encrypting the first encrypted ID of the physical goods according to a second encryption algorithm, encrypting the digital goods for which the client has made a request for purchase according to the second encryption algorithm, and transferring the second encrypted ID and the encrypted digital goods to the client, when selling the digital goods; and
a client interface section for registering the client to the controller as a genuine proprietor of the physical goods by transfer to the controller of information including at least the assignable identification name corresponding to the inherent ID given to the physical goods, making the request for purchase of the digital goods based on the assignable identification name and a selection of digital goods desired for purchase after the registration, and transferring the encrypted digital goods and the second encrypted ID to the physical goods when the second encrypted ID and the encrypted digital goods are transferred to the client interface section from the controller,
wherein the physical goods decrypts the second encrypted ID transferred from the client interface section according to a decryption algorithm, thereby extracting the first encrypted ID, and if the extracted first-encrypted ID coincides with the first encrypted ID given to the physical goods, decrypts the encrypted digital goods transferred from the client interface section according to the decryption algorithm and executes the decrypted digital goods.

2. An apparatus for preventing reproduction/distribution of digital goods by use of physical goods, comprising:
a digital goods section including digital goods to be sold via online from a business proprietor to a client
a physical goods to be operated by contents of the digital goods, the physical goods having an inherent ID given thereto, a first encrypted ID also given thereto and encrypted according to a first encryption algorithm from said inherent ID, and an assignable identification name for identifying the physical goods;
a controller for examining whether or not the client is a genuine proprietor of the physical goods based on information including the assignable identification name and the inherent ID of the physical goods, generating a second encrypted ID by encrypting the first encrypted ID of the physical goods according to a second encryption algorithm, encrypting the digital goods for which the client has made a request for purchase according to the second encryption algorithm, and transferring the second encrypted ID and the encrypted digital goods to the client, when selling the digital goods; and
a client interface section for registering the client to the controller as a genuine proprietor of the physical goods by transfer to the controller of information including at least the assignable identification name corresponding to the inherent ID given to the physical goods, making the request for purchase of the digital goods based on the assignable identification name and a selection of digital goods desired for purchase after the registration, and transferring the encrypted digital goods and the second encrypted ID to the physical goods when the second encrypted ID and the encrypted digital goods are transferred to the client interface section from the controller, wherein the physical goods decrypts the second encrypted ID and the encrypted digital goods transferred from the client interface section according to a decryption algorithm, thereby extracting the first encrypted ID and digital contents, and if the extracted first-encrypted ID coincides with the first encrypted ID given to the physical goods, executes the contents of the decrypted digital goods.

3. An apparatus for preventing reproduction/distribution of digital goods by use of physical goods according to claim 1, wherein both the inherent ID and the first encrypted ID are incorporated into the physical goods during manufacture of the physical goods.

4. An apparatus for preventing reproduction/distribution of digital goods by use of physical goods according to claim 1, wherein the first encrypted ID given to the physical goods can be inputted from outside of the physical goods after manufacture of the physical goods.

5. An apparatus for preventing reproduction/distribution of digital goods by use of physical goods, comprising:
a digital goods section including digital goods, said digital goods including a first operation portion and a second operation portion and saleable via online from a business proprietor to a client;
a physical goods to be operated by contents of the second operation portion of the digital goods, the physical goods having an inherent ID given thereto, a first encrypted ID also given thereto and encrypted according to a first encryption algorithm from said inherent ID and an assignable identification name for identifying the physical goods;
a controller for examining whether or not the client is a genuine proprietor of the physical goods based on information including the assignable identification name and the inherent ID of the physical goods, generating a second encrypted ID by encrypting the first encrypted ID of the physical goods according to a second encryption algorithm, encrypting the digital goods for which the client has made a request for purchase according to the second encryption algorithm, and transferring the second encrypted ID and the encrypted digital goods to the client, when selling the digital goods; and
a client interface section for registering the client to the controller as a genuine proprietor of the physical goods by transfer to the controller of information including at least the assignable identification name corresponding to the inherent ID given to the physical goods, making the request for purchase of the digital goods based on the assignable identification name and a selection of digital goods desired for purchase after the registration, separating the digital goods into a first execution portion and a second execution portion if the second encrypted ID and the digital goods requested for purchasing are transferred from the controller, and transferring the separated second execution portion and the second encrypted ID to the physical goods,
wherein the physical goods decrypts the second encrypted ID transferred from the client interface section according to a decryption algorithm, thereby extracting the first encrypted ID, and if the extracted first-encrypted ID coincides with the first encrypted ID given to the physical goods, executes contents of the second execution portion transferred from the client interface section, and
wherein when the contents of the second execution portion of the digital goods are executed in the physical goods, the client interface section executes the first execution portion of the digital goods in synchronization with the execution of the contents of the second execution portion.

6. An apparatus for preventing reproduction/distribution of digital goods by use of physical goods according to claim 5, wherein both the inherent ID and the first encrypted ID are incorporated into the physical goods during manufacture of the physical goods.

7. An apparatus for preventing reproduction/distribution of digital goods by use of physical goods according to claim 5, wherein the first encrypted ID given to the physical goods can be inputted from outside of the physical goods after manufacture of the physical goods.

8. An apparatus for preventing reproduction/distribution of digital goods by use of physical goods according to claim 5, wherein the physical goods prohibits the execution of the first execution portion of the digital goods in the client interface section if the extracted first-encrypted ID does not coincide with the first encrypted ID given to the physical goods.

9. An apparatus for preventing reproduction/distribution of digital goods by use of physical goods according to claim 5, wherein the physical goods is a storytelling device, and the second execution portion includes operation code for controlling operation of the physical goods according to contents of a story and narration for dictating the contents of the story.

10. An apparatus for preventing reproduction/distribution of digital goods by use of physical goods according to claim 5, wherein the controller simultaneously transfers to the client the second encrypted ID and the digital goods requested by the client for purchase.

11. An apparatus for preventing reproduction/distribution of digital goods by use of physical goods according to claim 9, wherein the client interface is a personal computer, and the first execution portion of the digital goods includes images and sound effects.

12. An apparatus for preventing reproduction/distribution of digital goods by use of physical goods, comprising:
a digital goods section including digital goods, said digital goods including a first operation portion and a second operation portion and saleable via online from a business proprietor to a client;
a physical goods to be operated by contents of the second operation portion of the digital goods, the physical goods having an inherent ID given thereto, a first encrypted ID also given thereto and encrypted according to a first encryption algorithm from said inherent ID, and an assignable identification name for identifying the physical goods;
a controller for examining whether or not the client is a genuine proprietor of the physical goods based on information including the assignable identification name and the inherent ID of the physical goods, generating a second encrypted ID by encrypting the first encrypted ID of the physical goods according to a second encryption algorithm, encrypting the digital goods for which the client has made a request for purchase according to the second encryption algorithm, and transferring the second encrypted ID and the encrypted digital goods to the client, when selling the digital goods; and
a client interface section for registering the client to the controller as a genuine proprietor of the physical goods by transfer to the controller of information including at least the assignable identification name corresponding to the inherent ID given to the physical goods, making the request for purchase of the digital goods based on the assignable identification name and a selection of digital goods desired for purchase after the registration, separating the digital goods into a first execution portion and a second execution portion if the second encrypted ID and the digital goods requested for purchasing are transferred from the controller, transferring the second encrypted ID to the physical goods, and transferring the second execution portion of the digital goods to the physical goods according to the request for transfer of the second execution portion of the digital goods made by the physical goods,
wherein the physical goods decrypts the second encrypted ID transferred from the client interface section according to a decryption algorithm, thereby extracting the first encrypted ID, and if the extracted first-encrypted ID coincides with the first encrypted ID given to the physical goods, makes request for transfer of the second execution portion of the digital goods to the client interface section and executes contents of the second execution portion of the digital goods transferred from the client interface section in response to the request for transfer, and
wherein when the contents of the second execution portion of the digital goods are executed in the physical goods, the client interface section executes the first execution portion of the digital goods in synchronization with the execution of the contents of the second execution portion.

13. An apparatus for preventing reproduction/distribution of digital goods by use of physical goods according to claim 12, wherein both the inherent ID and the first encrypted ID are incorporated into the physical goods during manufacture of the physical goods.

14. An apparatus for preventing reproduction/distribution of digital goods by use of physical goods according to claim 12, wherein the first encrypted ID given to the physical goods can be inputted from outside of the physical goods after manufacture of the physical goods.

15. An apparatus for preventing reproduction/distribution of digital goods by use of physical goods according to claim 12, wherein the physical goods prohibits the execution of the first execution portion of the digital goods in the client interface section if the extracted first-encrypted ID does not coincide with the first encrypted ID given to the physical goods.

16. An apparatus for preventing reproduction/distribution of digital goods by use of physical goods according to claim 12, wherein the physical goods is a storytelling device, and the second execution portion includes operation code for controlling operation of the physical goods according to contents of a story and narration for dictating the contents of the story.

17. An apparatus for preventing reproduction/distribution of digital goods by use of physical goods according to claim 12, wherein the controller simultaneously transfers to the client the second encrypted ID and the digital goods requested by the client for purchase.

18. An apparatus for preventing reproduction/distribution of digital goods by use of physical goods according to claim 16, wherein the client interface is a personal computer, and the first execution portion of the digital goods includes images and sound effects.

19. A method of preventing reproduction/distribution of digital goods by use of physical goods wherein the physical goods has an inherent ID given thereto, and a first encrypted ID also given thereto and encrypted from the inherent ID according to a first encryption algorithm, comprising the steps of:
obtaining the inherent ID of the physical goods by a client;
transferring the obtained inherent ID together with an assignable identification name for identifying the physical goods to a business proprietor;
examining whether or not a corresponding relationship between the assignable identification name and inherent ID of the physical goods has been registered on database of the business proprietor;
registering the physical goods on the database of the business proprietor by relating the assignable identification name of the physical goods to the first encrypted ID if it is judged in the examining step that the corresponding relationship has not been registered;
notifying the client of the registration of the physical goods on database of the business proprietor;
determining a digital goods to be purchased and transferring both a code of goods and the assignable identification name corresponding to the digital goods to the business proprietor;
identifying the first encrypted ID corresponding to the assignable identification name transferred together with the code of goods by reference to the database of the business proprietor;
encrypting the first encrypted ID according to a second encryption algorithm to generate a second encrypted ID if the first encrypted ID corresponding to the assignable identification name is identified in the identifying step;
encrypting the digital goods corresponding to the code of goods according to the second encryption algorithm;
transferring the second encrypted ID and the encrypted digital goods to a client interface section; transferring the second encrypted ID and the encrypted digital goods transferred to the client interface section to the physical goods;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods;
decrypting the encrypted digital goods according to the decryption algorithm if, in the comparing step, the first encrypted ID generated by the decryption of the second encrypted ID coincides with the encrypted ID kept in the physical goods; and
executing the decrypted digital goods.

20. A method of preventing reproduction/distribution of digital goods by use of physical goods according to claim 19,
wherein the step of obtaining the inherent ID is for the client to read the inherent ID from the physical goods by initializing the physical goods through the client interface section.

21. A method of preventing reproduction/distribution of digital goods by use of physical goods according to claim 19,
wherein the step of obtaining the inherent ID is to read the inherent ID which is provided to be identifiable on the outside of the physical goods.

22. A method of preventing reproduction/distribution of digital goods by use of physical goods wherein the physical goods has an inherent ID given thereto, and a first encrypted ID also given thereto and encrypted the inherent ID according to a first encryption algorithm from, comprising the steps of:
obtaining the inherent ID of the physical goods by a client;
transferring the obtained inherent ID together with an assignable identification name for identifying the physical goods to a business proprietor;
examining whether or not a corresponding relationship between the assignable identification name and inherent ID of the physical goods has been registered on database of the business proprietor;
registering the physical goods on the database of the business proprietor by relating the assignable identification name of the physical goods to the first encrypted ID if it is judged in the examining step that the corresponding relationship has not been registered;
notifying the client of the registration of the physical goods on database of the business proprietor;
determining a digital goods to be purchased and transferring both a code of goods and the assignable identification name corresponding to the digital goods to the business proprietor;
identifying the first encrypted ID corresponding to the assignable identification name transferred together with the code of goods by reference to the database of the business proprietor;
encrypting the first encrypted ID according to a second encryption algorithm to generate a second encrypted ID if the first encrypted ID corresponding to the assignable identification name is identified in the identifying step;
encrypting the digital goods corresponding to the code of goods according to the second encryption algorithm; transferring the second encrypted ID and the encrypted digital goods to a client interface section;
transferring the second encrypted ID and the encrypted digital goods transferred to the client interface section to the physical goods;
decrypting the second encrypted ID and the encrypted digital goods transferred to the physical goods according to a decryption algorithm corresponding to the second encryption algorithm;
comparing the first encrypted ID generated by the decryption of the second encrypted ID with the first encrypted ID given to the physical goods; and
executing the decrypted digital goods if, in the comparing step, the first encrypted ID generated by the decryption of the second encrypted ID coincides with the first encrypted ID given to the physical goods.

23. A method of preventing reproduction/distribution of digital goods by use of physical goods according to claim 22,
wherein the step of obtaining the inherent ID is for the client to read the inherent ID from the physical goods by initializing the physical goods through the client interface section.

24. A method of preventing reproduction/distribution of digital goods by use of physical goods according to claim 22,
wherein the step of obtaining the inherent ID is to read the inherent ID which is provided to be identifiable on the outside of the physical goods.

25. A method of preventing reproduction/distribution of digital goods by use of physical goods wherein the physical goods has an inherent ID given thereto, and a first encrypted ID also given thereto and encrypted from the inherent ID according to a first encryption algorithm, comprising the steps of:
obtaining the inherent ID of the physical goods by a client;
transferring the obtained inherent ID together with an assignable identification name for identifying the physical goods to a business proprietor;
examining whether or not a corresponding relationship between the assignable identification name and inherent ID of the physical goods has been registered on database of the business proprietor;
registering the physical goods on the database of the business proprietor by relating the assignable identification name of the physical goods to the first encrypted ID if it is judged in the examining step that the corresponding relationship has not been registered;
notifying the client of the registration of the physical goods on database of the business proprietor;
determining a digital goods to be purchased which comprises a first execution portion and a second execution portion, and transferring both a code of goods and the assignable identification name corresponding to the digital goods to the business proprietor;
identifying the first encrypted ID corresponding to the assignable identification name transferred together with the code of goods by reference to the database of the business proprietor;
encrypting the first encrypted ID according to a second encryption algorithm to generate a second encrypted ID if the first encrypted ID corresponding to the assignable identification name is identified in the identifying step;
transferring the second encrypted ID and the digital goods corresponding to the code of goods to a client interface section;
separating the digital goods transferred to the client interface section into the first execution portion and the second execution portion;
transferring the second encrypted ID transferred to the client interface section to the physical goods;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods;
requesting the client interface section to transfer the second execution portion of the digital goods if, in the comparing step, the first encrypted ID generated by the decryption of the second encrypted ID coincides with the first encrypted ID given to the physical goods; and
executing the physical goods according to contents of the second execution portion of the digital goods transferred from the client interface section in response to the request for transfer of the digital goods and simultaneously executing contents of the first execution portion of the digital goods in the client interface section.

26. A method of preventing reproduction/distribution of digital goods by use of physical goods wherein the physical goods has an inherent ID given thereto, and a first encrypted ID also given thereto and encrypted from the inherent ID according to a first encryption algorithm, comprising the steps of:
obtaining the inherent ID of the physical goods by a client,
transferring the obtained inherent ID together with an assignable identification name for identifying the physical goods to a business proprietor;
examining whether or not a corresponding relationship between the assignable identification name and inherent ID of the physical goods has been registered on database of the business proprietor;
registering the physical goods on the database of the business proprietor by relating the assignable identification name of the physical goods to the first encrypted ID if it is judged in the examining step that the corresponding relationship has not been registered;
notifying the client of the registration of the physical goods on database of the business proprietor;
determining a digital goods to be purchased which comprises a first execution portion and a second execution portion, and transferring both a code of goods and the assignable identification name corresponding to the digital goods to the business proprietor;
identifying the first encrypted ID corresponding to the assignable identification name transferred together with the code of goods by reference to the database of the business proprietor;
encrypting the first encrypted ID according to a second encryption algorithm to generate a second encrypted ID if the first encrypted ID corresponding to the assignable identification name is identified in the identifying step;
transferring the second encrypted ID and the digital goods corresponding to the code of goods to a client interface section;
separating the digital goods transferred to the client interface section into the first execution portion and the second execution portion;
transferring the separated second execution portion of the digital goods and the second encrypted ID transferred to the client interface section to the physical goods; decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods; and
executing the physical goods according to contents of the second execution portion of the digital goods transferred from the client interface section and simultaneously executing contents of the first execution portion of the digital goods in the client interface section, if, in the comparing step, the first encrypted ID generated by the decryption of the second encrypted ID coincides with the first encrypted ID given to the physical goods.

27. A method of preventing reproduction/distribution of digital goods by use of physical goods wherein the physical goods has an inherent ID given thereto, and a first encrypted ID also given thereto and encrypted from the inherent ID according to a first encryption algorithm comprising the steps of:
obtaining the inherent ID of the physical goods on the side of a client;
transferring the obtained inherent ID together with an assignable identification name for identifying the physical goods to a business proprietor;
examining whether or not a corresponding relationship between the assignable identification name and inherent ID of the physical goods has been registered on database of the business proprietor;
registering the physical goods on the database of the business proprietor by relating the assignable identification name of the physical goods to the first encrypted ID if it is judged in the examining step that the corresponding relationship has not been registered;
notifying the client of the registration of the physical goods on database of the business proprietor;
determining a digital goods to be purchased which comprises a first execution portion and a second execution portion, and transferring both a code of goods and the assignable identification name corresponding to the digital goods to the business proprietor;
identifying the first encrypted ID corresponding to the assignable identification name transferred together with the code of goods by reference to the database of the business proprietor;
encrypting the first encrypted ID according to a second encryption algorithm to generate a second encrypted ID if the first encrypted ID corresponding to the assignable identification name is identified in the identifying step;
transferring the second encrypted ID and the digital goods corresponding to the code of goods to a client interface section;
transferring the second encrypted ID transferred to the client interface section to the physical goods;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods; and
requesting the client interface section to transfer the second execution portion of the digital goods if, in the comparing step, the first encrypted ID generated by the decryption of the second encrypted ID coincides with the first encrypted ID given to the physical goods;
separating the digital goods transferred to the client interface section into the first execution portion and the second execution portion in response to the request for transfer of the digital goods;
transferring the separated second execution portion of the digital to the physical goods; and
executing the physical goods according to contents of the second execution portion of the digital goods transferred from the client interface section in response to the request for transfer of the digital goods and simultaneously executing contents of the first execution portion of the digital goods in the client interface section.

28. A method of preventing reproduction/distribution of digital goods by use of physical goods wherein the physical goods has an inherent ID given thereto, a first encrypted ID also given thereto and encrypted from said inherent ID according to a first encryption algorithm and an assignable identification name for identifying the physical goods and the digital goods is sold via online from a business proprietor to a client, the method comprising the steps of:
transferring information on the physical goods including at least the assignable identification name of the physical goods of which a corresponding relationship with the inherent ID has been registered on a database of the business proprietor and information on the digital goods including at least code of goods corresponding to the digital goods to be purchased, from the client to the business proprietor;
examining whether or not the client is a genuine proprietor of the physical goods by reference to the database of the business proprietor based on the information on the physical goods;
encrypting the first encrypted ID corresponding to the identification name transferred to the business proprietor according to a second encryption algorithm, thereby generating a second encrypted ID if the genuine proprietor of the physical goods is confirmed in the examining step;
encrypting the digital goods indicated by the information on the digital goods according to the second encryption algorithm;
transferring the second encrypted ID and the encrypted digital goods to a client interface section;
transferring the second encrypted ID and the encrypted digital goods transferred to the client interface section to the physical goods;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods;
decrypting the encrypted digital goods according to the decryption algorithm if, in the comparing step, the first encrypted ID generated by the decryption of the second encrypted ID coincides with the first encrypted ID given to the physical goods; and
operating the physical goods according to contents of the decrypted digital goods.

29. A method of preventing reproduction/distribution of digital goods by use of physical goods wherein the physical goods has an inherent ID given thereto, a first encrypted ID also given thereto and encrypted from said inherent ID according to a first encryption algorithm and an assignable identification name for identifying the physical goods and the digital goods is sold via online from a business proprietor to a client, the method comprising the steps of:
transferring information on the physical goods including at least the assignable identification name of the physical goods of which a corresponding relationship with the inherent ID has been registered on a database of the business proprietor and information on the digital goods including at least code of goods corresponding to the digital goods to be purchased, from the client to the business proprietor;
examining whether or not the client is a genuine proprietor of the physical goods by reference to the database of the business proprietor based on the information on the physical goods;
encrypting the first encrypted ID corresponding to the identification name transferred to the business proprietor according to a second encryption algorithm, thereby generating a second encrypted ID if the genuine proprietor of the physical goods is confirmed in the examining step;
encrypting the digital goods indicated by the information on the digital goods according to the second encryption algorithm;
transferring the second encrypted ID and the encrypted digital goods to a client interface section;
transferring the second encrypted ID and the encrypted digital goods transferred to the client interface section to the physical goods;
decrypting the second encrypted ID and the encrypted digital goods transferred to the physical goods according to a decryption algorithm corresponding to the second encryption algorithm;
comparing the first encrypted ID generated by the decryption of the second encrypted ID with the first encrypted ID given to the physical goods; and
operating the physical goods according to contents of the decrypted digital goods if, in the comparing step, the first encrypted ID generated by the decryption of the second encrypted ID coincides with the first encrypted ID given to the physical goods.

30. A method of preventing reproduction/distribution of digital goods by use of physical goods wherein the physical goods has an inherent ID given thereto, a first encrypted ID also given thereto and encrypted from said inherent ID according to a first encryption algorithm and an assignable identification name for identifying the physical goods, and the digital goods comprises a first execution portion and a second execution portion and is sold via online from a business proprietor to a client, the method comprising the steps of:
transferring information on the physical goods including at least the assignable identification name of the physical goods of which a corresponding relationship with the inherent ID has been registered on a database of the business proprietor and information on the digital goods including at least code of goods corresponding to the digital goods to be purchased, from the client to the business proprietor;
examining whether or not the client is a genuine proprietor of the physical goods by reference to the database of the business proprietor based on the information on the physical goods;
encrypting the first encrypted ID corresponding to the assignable identification name transferred to the business proprietor according to a second encryption algorithm, thereby generating a second encrypted ID if the genuine proprietor of the physical goods is confirmed in the examining step;
transferring the second encrypted ID and the digital goods indicated by the information on the digital goods to a client interface section;
separating the digital goods transferred to the client interface section into the first execution portion and the second execution portion;
transferring the second encrypted ID transferred to the client interface section to the physical goods;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods;
requesting the client interface section to transfer the second execution portion of the digital goods if, in the comparing step, the first encrypted ID generated by the decryption of the second encrypted ID coincides with the first encrypted ID given to the physical goods; and
executing the physical goods according to contents of the second execution portion of the digital goods transferred from the client interface section in response to the request for transfer of the digital goods and simultaneously executing contents of the first execution portion of the digital goods in the client interface section.

31. A method of preventing reproduction/distribution of digital goods by use of physical goods wherein the physical goods has an inherent ID given thereto, a first encrypted ID also given thereto and encrypted from said inherent ID according to a first encryption algorithm and an assignable identification name for identifying the physical goods, and the digital goods comprises a first execution portion and a second execution portion and is sold via online from a business proprietor to a client, the method comprising the steps of:
transferring information on the physical goods including at least the assignable identification name of the physical goods of which a corresponding relationship with the inherent ID has been registered on a database of the business proprietor and information on the digital goods including at least code of goods corresponding to the digital goods to be purchased, from the client to the business proprietor;
examining whether or not the client is a genuine proprietor of the physical goods by reference to the database of the business proprietor based on the information on the physical goods;
encrypting the first encrypted ID corresponding to the assignable identification name transferred to the business proprietor according to a second encryption algorithm, thereby generating a second encrypted ID if the genuine proprietor of the physical goods is confirmed in the examining step;
transferring the second encrypted ID and the digital goods indicated by the information on the digital goods to a client interface section;
separating the digital goods transferred to the client interface section into the first execution portion and the second execution portion;
transferring the separated second execution portion of the digital goods and the second encrypted ID to the physical goods;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods; and
executing the physical goods according to contents of the second execution portion of the digital goods transferred from the client interface section and simultaneously executing contents of the first execution portion of the digital goods in the client interface section, if, in the comparing step, the first encrypted ID generated by the decryption of the second encrypted ID coincides with the first encrypted ID given to the physical goods.

32. A method of preventing reproduction/distribution of digital goods by use of physical goods wherein the physical goods has an inherent ID given thereto, a first encrypted ID also given thereto and encrypted from said inherent ID according to a first encryption algorithm and an assignable identification name for identifying the physical goods, and the digital goods comprises a first execution portion and a second execution portion and is sold via online from a business proprietor to a client, the method comprising the steps of:
transferring information on the physical goods including at least the assignable identification name of the physical goods of which a corresponding relationship with the inherent ID has been registered on a database of the business proprietor and information on the digital goods including at least code of goods corresponding to the digital goods to be purchased, from the client to the business proprietor;
examining whether or not the client is a genuine proprietor of the physical goods by reference to the database of the business proprietor based on the information on the physical goods;
encrypting the first encrypted ID corresponding to the assignable identification name transferred to the business proprietor according to a second encryption algorithm, thereby generating a second encrypted ID if the genuine proprietor of the physical goods is confirmed in the examining step;
transferring the second encrypted ID and the digital goods indicated by the information on the digital goods to a client interface section;
transferring the second encrypted ID to the physical goods;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods;
requesting the client interface section to transfer the second execution portion of the digital goods if, in the comparing step, the first encrypted ID generated by the decryption of the second encrypted ID coincides with the first encrypted ID given to the physical goods;
separating the digital goods transferred to the client interface section into the first execution portion and the second execution portion in response to the request for transfer of the digital goods;
transferring the separated second execution portion of the digital to the physical goods; and
executing the physical goods according to contents of the second execution portion of the digital goods transferred from the client interface section and simultaneously executing contents of the first execution portion of the digital goods in the client interface section.

33. A method of preventing reproduction/distribution of digital goods by use of physical goods so as to permit sending a gift of the digital goods to a third party and receiving the gift wherein the digital goods is executed in physical goods, wherein the physical goods has an inherent ID given thereto, ID information including a first encrypted ID which is also given to the physical goods and encrypted from said inherent ID according to a first encryption algorithm and an assignable identification name for identifying the physical goods, and wherein the digital goods is sold via online to a client, the method comprising the steps of:
transferring information on a gift sender, information on the digital goods to be purchased, and information on a gift recipient including the assignable identification name of the physical goods held by the gift recipient from the gift sender to a business proprietor;
extracting the ID information of the physical goods held by the gift recipient by reference to a database of the business proprietor in which a corresponding relationship between the assignable identification name and the inherent ID has been registered, based on at least the assignable identification name;
encrypting the first encrypted ID among the extracted ID information according to a second encryption algorithm, thereby generating a second encrypted ID; encrypting the digital goods selected by the gift sender according to the second encryption algorithm;
transferring the second encrypted ID and the encrypted digital goods to a interface section of the gift recipient;
transferring the second encrypted ID and the encrypted digital goods transferred to the interface section of the gift recipient to the physical goods of the gift recipient;
decrypting the second encrypted ID transferred to the physical goods according to a decryption algorithm corresponding to the second encryption algorithm; comparing the first encrypted ID generated by the decryption of the second encrypted ID with the first encrypted ID given to the physical goods;
decrypting the encrypted digital goods according to the decryption algorithm if, in the comparing step, the first encrypted ID generated by the decryption of the second encrypted ID coincides with the first encrypted ID given to the physical goods; and
executing contents of the decrypted digital goods provided as the gift in the physical goods.

34. A method of preventing reproduction/distribution of digital goods by use of physical goods so as to permit sending a gift of the digital goods to a third party and receiving the gift according to claim 33, wherein the step of transferring the second encrypted ID and the encrypted digital goods to the interface section of the gift recipient includes the steps of:
transferring information including information that the digital goods has been provided by the gift sender, URL of the business proprietor, and guide information for downloading the gift to the interface section of the gift recipient, to an email address of the gift recipient;
providing an access to the URL of the business proprietor by the gift recipient by confirming the email; and
downloading the digital goods provided as the gift by the gift recipient from the URL of the business proprietor to the interface section.

35. A method of preventing reproduction/distribution of digital goods by use of physical goods so as to permit sending a gift of the digital goods to a third party and receiving the gift wherein the digital goods is executed in physical goods, wherein the physical goods has an inherent ID given thereto, ID information including a first encrypted ID which is also given to the physical goods and encrypted from said inherent ID according to a first encryption algorithm and an assignable identification name for identifying the physical goods, and wherein the digital goods is sold via online to a client, the method comprising the steps of:
transferring information on a gift sender, information on the digital goods to be purchased, and information on a gift recipient including the assignable identification name of the physical goods held by the gift recipient from the gift sender to a business proprietor;
extracting the ID information of the physical goods held by the gift recipient by reference to a database of the business proprietor in which a corresponding relationship between the assignable identification name and the inherent ID has been registered, based on at least the identification name;
encrypting the first encrypted ID among the extracted ID information according to a second encryption algorithm, thereby generating a second encrypted ID; encrypting the digital goods selected by the gift sender according to the second encryption algorithm;
transferring the second encrypted ID and the encrypted digital goods to a interface section of the gift recipient;
transferring the second encrypted ID and the encrypted digital goods transferred to the interface section of the gift recipient to the physical goods of the gift recipient;
decrypting the second encrypted ID and the encrypted digital goods transferred to the physical goods according to a decryption algorithm corresponding to the second encryption algorithm;
comparing the first encrypted ID generated by the decryption of the second encrypted ID with the first encrypted ID given to the physical goods; and
executing contents of the decrypted digital goods provided as the gift in the physical goods if, in the comparing step, the first encrypted ID generated by the decryption of the second encrypted coincides with the first encrypted ID given to the physical goods.

36. A method of preventing reproduction/distribution of digital goods by use of physical goods so as to permit sending a gift of the digital goods to a third party and receiving the gift according to claim 35, wherein the step of transferring the second encrypted ID and the encrypted digital goods to the interface section of the gift recipient includes the steps of:
transferring information including information that the digital goods has been provided by the gift sender, URL of the business proprietor, and guide information for downloading the gift to the interface section of the gift recipient, to an email address of the gift recipient;
providing an access to the URL of the business proprietor by the gift recipient by confirming the email; and
downloading the digital goods provided as the gift by the gift recipient from the URL of the business proprietor to the interface section

37. A method of preventing reproduction/distribution of digital goods by use of physical goods so as to permit sending a gift of the digital goods to a third party and receiving the gift wherein the digital goods sold via online to a client comprises a first execution portion and a second execution portion, wherein the second execution portion of the digital goods is executed in physical goods, and wherein the physical goods has an inherent ID given thereto, ID information including a first encrypted ID which is also given to the physical goods and encrypted from said inherent ID according to a first encryption algorithm and an assignable identification name for identifying the physical goods, the method comprising the steps of:
transferring information on a gift sender, information on the digital goods to be purchased, and information on a gift recipient including the assignable identification name of the physical goods held by the gift recipient from the gift sender to a business proprietor;
extracting the ID information of the physical goods held by the gift recipient by reference to a database of the business proprietor in which a corresponding relationship between the assignable identification name and the inherent ID has been registered, based on at least the assignable identification name;
encrypting the first encrypted ID among the extracted ID information according to a second encryption algorithm, thereby generating a second encrypted ID;
transferring the second encrypted ID and the digital goods selected by the gift sender to a interface section of the gift recipient;
separating the digital goods into the first execution portion and the second execution portion;
transferring the second encrypted ID transferred to the interface section of the gift recipient to the physical goods of the gift recipient;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods;
requesting the interface section of the gift recipient to transfer the second execution portion of the digital goods if, in the comparing step, the first encrypted ID generated by the decryption of the second encrypted ID coincides with the first encrypted ID given to the physical goods; and
executing contents of the second execution portion of the digital goods transferred from the interface section of the gift recipient in response to the request for transfer in the physical goods and simultaneously executing contents of the first execution portion of the digital goods in the interface section of the gift recipient.

38. A method of preventing reproduction/distribution of digital goods by use of physical goods so as to permit sending a gift of the digital goods to a third party and receiving the gift according to claim 37, wherein the step of transferring the second encrypted ID and the encrypted digital goods to the interface section of the gift recipient includes the steps of:
transferring information including information that the digital goods has been provided by the gift sender, URL of the business proprietor, and guide information for downloading the gift to the interface section of the gift recipient, to an email address of the gift recipient;
providing an access to the URL of the business proprietor by the gift recipient by confirming the email; and
downloading the digital goods provided as the gift by the gift recipient from the URL of the business proprietor to the interface section.

39. A method of preventing reproduction/distribution of digital goods by use of physical goods so as to permit sending a gift of the digital goods to a third party and receiving the gift wherein the digital goods sold via online to a client comprises a first execution portion and a second execution portion, wherein the second execution portion of the digital goods is executed in physical goods, and wherein the physical goods has an inherent ID given thereto, ID information including a first encrypted ID which is also given to the physical goods and encrypted from said inherent ID according to a first encryption algorithm and an assignable identification name for identifying the physical goods, the method comprising the steps of:
transferring information on a gift sender, information on the digital goods to be purchased, and information on a gift recipient including the assignable identification name of the physical goods held by the gift recipient from the gift sender to a business proprietor;
extracting the ID information of the physical goods held by the gift recipient by reference to a database of the business proprietor in which a corresponding relationship between the assignable identification name and the inherent ID has been registered, based on at least the assignable identification name;
encrypting the first encrypted ID among the extracted ID information according to a second encryption algorithm, thereby generating a second encrypted ID;
transferring the second encrypted ID and the digital goods selected by the gift sender to a interface section of the gift recipient;
separating the digital goods into the first execution portion and the second execution portion;
transferring the separated second execution portion and the second encrypted ID transferred to the interface section of the gift recipient to the physical goods of the gift recipient;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods; and
executing contents of the second execution portion of the digital goods in the physical goods and simultaneously executing contents of the first execution portion of the digital goods in the interface section of the gift recipient, if, in the comparing step, the first encrypted ID generated by the decryption of the second encrypted ID coincides with the first encrypted ID given to the physical goods.

40. A method of preventing reproduction/distribution of digital goods by use of physical goods so as to permit sending a gift of the digital goods to a third party and receiving the gift according to claim 39 wherein the step of transferring the second encrypted ID and the encrypted digital goods to the interface section of the gift recipient includes the steps of:
transferring information including information that the digital goods has been provided by the gift sender, URL of the business proprietor, and guide information for downloading the gift to the interface section of the gift recipient, to an email address of the gift recipient;
providing an access to the URL of the business proprietor by the gift recipient by confirming the email; and
downloading the digital goods provided as the gift by the gift recipient from the URL of the business proprietor to the interface section.

41. A method of preventing reproduction/distribution of digital goods by use of physical goods so as to permit sending a gift of the digital goods to a third party and receiving the gift wherein the digital goods sold via online to a client comprises a first execution portion and a second execution portion, wherein the second execution portion of the digital goods is executed in physical goods, and wherein the physical goods has an inherent ID given thereto, ID information including a first encrypted ID which is also given to the physical goods and encrypted from said inherent ID according to a first encryption algorithm and an assignable identification name for identifying the physical goods, the method comprising the steps of:
transferring information on a gift sender, information on the digital goods to be purchased, and information on a gift recipient including the assignable identification name of the physical goods held by the gift recipient from the gift sender to a business proprietor;
extracting the ID information of the physical goods held by the gift recipient by reference to a database of the business proprietor in which a corresponding relationship between the assignable identification name and the inherent ID has been registered, based on at least the assignable identification name;
encrypting the first encrypted ID among the extracted ID information according to a second encryption algorithm, thereby generating a second encrypted ID;
transferring the second encrypted ID and the digital goods selected by the gift sender to a interface section of the gift recipient;
transferring the second encrypted ID transferred to the interface section of the gift recipient to the physical goods of the gift recipient;
decrypting the second encrypted ID transferred to the physical goods according to a decryption algorithm corresponding to the second encryption algorithm;
comparing the first encrypted ID generated by the decryption of the second encrypted ID with the first encrypted ID given to the physical goods;
requesting the interface section of the gift recipient to transfer the second execution portion of the digital goods if, in the comparing step, the first encrypted ID generated by the decryption of the second encrypted ID coincides with the first encrypted ID given to the physical goods;
separating the digital goods transferred to the interface section of the gift recipient into the first execution portion and the second execution portion in response to the request for
transfer of the second execution portion of the digital goods; transferring the separated second execution portion of the digital to the physical goods; and
executing contents of the second execution portion of the digital goods transferred to the physical goods in the physical goods and simultaneously executing contents of the first execution portion of the digital goods in the interface section of the gift recipient.

42. A method of preventing reproduction/distribution of digital goods by use of physical goods so as to permit sending a gift of the digital goods to a third party and receiving the gift according to claim 41, wherein the step of transferring the second encrypted ID and the encrypted digital goods to the interface section of the gift recipient includes the steps of:
transferring information including information that the digital goods has been provided by the gift sender, URL of the business proprietor, and guide information for downloading the gift to the interface section of the gift recipient, to an email address of the gift recipient;
providing an access to the URL of the business proprietor by the gift recipient by confirming the email; and
downloading the digital goods provided as the gift by the gift recipient from the URL of the business proprietor to the interface section.

43. A system of preventing reproduction/distribution of digital contents sold via online by use of an operation device, comprising:
the operation device for executing a part of the digital contents the operation device including an inherent ID given thereto, a first encrypted ID also given thereto and encrypted according to a first encryption algorithm from said inherent ID, and an assignable identification name for identifying the operation device;
a client interface section for providing registration information including the inherent ID given to the operation device, the assignable identification name for the operation device and client information to register the operation device, and for providing information on digital contents to be purchased and purchase information including the assignable identification name to purchase the digital contents after registration;
a central controller for registering the registration information in its own database, examining whether the client is a genuine proprietor of the operation device based on the assignable identification name, and if the client is determined to be a genuine proprietor, providing an authentication code including a second encrypted ID generated by encrypting the first encrypted ID stored in the database of the central controller according to a second encryption algorithm when the authentication code is requested;
an electronic commerce controller for requesting the authentication code to the central controller based on the digital contents information and the purchase information including the assignable identification name, generating a signal for requesting the digital contents selected by the client if the authentication code is provided from the central controller, and
providing the digital contents and the authentication code to be provided according to the requests with the client interface section; and
a digital contents controller for providing the requested digital contents with the electronic commerce controller when the signal for requesting the digital contents is received,
wherein the client interface section transfers the part of the digital contents and the authentication code to the operation device when the purchased digital contents and the authentication code are received,
wherein the operation device decrypts the second encrypted ID included in authentication code according to a decryption algorithm corresponding to the second encryption algorithm to extract the first encrypted ID when the part of the digital contents and the authentication code are received and executes the part of the digital contents transferred from the client interface section only when the extracted first-encrypted ID coincides with the first encrypted ID given to the operation device, and
wherein the client interface section executes the remaining part of the digital contents except the part which has been transferred to the operation device and is executed by the operation device, in synchronization with the execution of the part on the side of the operation device.

44. A system of preventing reproduction/distribution of digital contents sold via online by use of an operation device according to claim 43,
wherein the client interface section reads the inherent ID from the operation device by an operation device set-up program.

45. A system of preventing reproduction/distribution of digital contents sold via online by use of an operation device according to claim 43,
wherein the client interface section provides the inherent ID identified from outside of the operation device as the registration information.

46. A system of preventing reproduction/distribution of digital contents sold via online by use of an operation device according to claim 43,
wherein the central controller, the electronic commerce controller, and the digital contents controller are managed by a business proprietor.

47. A system of preventing reproduction/distribution of digital contents sold via online by use of an operation device according to claim 43,
wherein the central controller, the electronic commerce controller, and the digital contents controller are separately managed.

48. A system of preventing reproduction/distribution of digital contents sold via online by use of an operation device according to claim 43,
wherein a business proprietor who manages the central controller and the electronic commerce controller is different from a business proprietor who manages the digital contents controller.

49. A system of preventing reproduction/distribution of digital contents sold via online by use of an operation device, comprising:
the operation device for executing a part of the digital contents, the operation device including an inherent ID given thereto, a first encrypted ID also given thereto and encrypted according to a first encryption algorithm from said inherent ID, and an assignable identification name for identifying the operation device;
a client interface section for providing registration information including the inherent ID given to the operation device, the assignable identification name for the operation device and client information to register the operation device, and for providing information on digital contents to be purchased and purchase information including the assignable identification name to purchase the digital contents after registration;
a central controller for registering the registration information in its own database, examining whether the client is a genuine proprietor of the operation device based on the assignable identification name, and if the client is determined to be to a genuine proprietor, providing an authentication code including a second encrypted ID generated by encrypting the first encrypted ID stored in the database of the central controller according to a second encryption algorithm when the authentication code is requested;
an electronic commerce controller for requesting the authentication code to the central controller based on the digital contents information and the purchase information including the assignable identification name, generating a signal for requesting the digital contents selected by the client if the authentication code is provided from the central controller, and providing the digital contents and the authentication code to be provided according to the requests with the client interface section; and
a digital contents controller for providing the requested digital contents with the electronic commerce controller when the signal for requesting the digital contents is received,
wherein the client interface section transfers the authentication code to the operation device when the purchased digital contents and the authentication code are received,
wherein the operation device decrypts the second encrypted ID included in authentication code according to a decryption algorithm corresponding to the second encryption algorithm to extract the first encrypted ID when the authentication code is received, receives the part of the digital contents from the client interface section only when the extracted first-encrypted ID coincides with the first encrypted ID given to the operation device, and executes the part of the digital contents, and
wherein the client interface section executes the remaining part of the digital contents except the part which has been transferred to the operation device, in synchronization with the execution of the part on the side of the operation device.

50. A system of preventing reproduction/distribution of digital contents sold via online by use of an operation device according to claim 49,
wherein the client interface section reads the inherent ID from the operation device by an operation device set-up program.

51. A system of preventing reproduction/distribution of digital contents sold via online by use of an operation device according to claim 49,
wherein the client interface section provides the inherent ID identified from outside of the operation device as the registration information.

52. A system of preventing reproduction/distribution of digital contents sold via online by use of an operation device according to claim 49,
wherein the central controller, the electronic commerce controller, and the digital contents controller are managed by a business proprietor.

53. A system of preventing reproduction/distribution of digital contents sold via online by use of an operation device according to claim 49,
wherein the central controller, the electronic commerce controller, and the digital contents controller are separately managed.

54. A system of preventing reproduction/distribution of digital contents sold via online by use of an operation device according to claim 49,
wherein a business proprietor who manages the central controller and the electronic commerce controller is different from a business proprietor who manages the digital contents controller.

55. An apparatus for preventing reproduction/distribution of digital goods sold via online to a client by use of physical goods having an inherent ID and a first encrypted ID from said inherent ID encrypted according to a first encryption algorithm for executing a part of the sold digital goods,
wherein the physical goods comprises a controller for determining the execution of the part of the sold digital goods depending on a result of comparison of a decrypted ID generated by decrypting a second encrypted ID, which had been generated by encrypting the first encrypted ID according to a second encryption algorithm and transferred to the physical goods when selling the digital goods, with the first encrypted ID given to the physical goods.

56. An apparatus for preventing reproduction/distribution of digital goods sold via online to a client by use of physical goods having a first encrypted ID for executing a part of the sold digital goods,
wherein the physical goods comprises a controller for determining the execution of the part of the sold digital goods depending on a result of comparison of a decrypted ID generated by decrypting a second encrypted ID, which had been generated by encrypting the first encrypted ID according to an encryption algorithm and transferred to the physical goods when selling the digital goods, according to a decryption algorithm corresponding to the encryption algorithm with the first encrypted ID given to the physical goods.

57. A method of preventing reproduction/distribution of digital goods transferred via online by use of physical goods having a first encrypted ID given thereto for executing a part of the transferred digital goods, comprising the steps of:
requesting transfer of the digital goods to a proprietor of the physical goods by purchasing of the digital goods;
examining whether or not the proprietor of the physical goods is a genuine one;
transferring the digital goods and a second encrypted ID generated by encrypting the first encrypted ID according to a predetermined encryption algorithm to the proprietor of the physical goods;
decrypting the second encrypted ID transferred to the proprietor of the physical goods according to a decryption algorithm corresponding to the predetermined encryption algorithm; and
determining the execution of the part of the transferred digital goods depending on a result of comparison of the decrypted ID with the first encrypted ID given to the physical goods.

58. A method of preventing reproduction/distribution of digital goods comprising a first execution portion and a second execution portion transferred via online by use of physical goods having a first encrypted ID given thereto for executing the second execution portion of the digital goods, comprising the steps of:
requesting transfer of the digital goods to a proprietor of the physical goods by purchasing of the digital goods;
examining whether or not of the physical goods is a genuine one;
transferring the digital goods and a second encrypted ID generated by encrypting the first encrypted ID according to a predetermined encryption algorithm to the proprietor of the physical goods;
decrypting the second encrypted ID transferred to the proprietor of the physical goods according to a decryption algorithm corresponding to the predetermined encryption algorithm;
determining whether or not the decrypted ID coincides with the first encrypted ID given to the physical goods; and
executing the second execution portion of the digital goods in the physical goods and simultaneously executing the first execution portion of the digital goods in an interface section of the proprietor connected to the physical goods in synchronization with the execution of the second execution portion only when, in the determining step, the decrypted ID coincides with the first encrypted ID given to the physical goods.

59. An apparatus for preventing reproduction/distribution of digital goods transferred via online by use of physical goods having a first encrypted ID given thereto for executing a part of the transferred digital goods,
wherein the physical goods determines the execution of the part of the transferred digital goods depending on a result of comparison of a decrypted ID generated by decrypting a second encrypted ID, which had been generated by encrypting the first encrypted ID according to a predetermined encryption algorithm and transferred to the physical goods, according to a decryption algorithm corresponding to the predetermined encryption algorithm, with the first encrypted ID given to the physical goods.
